(19) United States
(12) Patent Application Publication
(10) Pub. No.: US 2025/0148648 A1
(43) Pub. Date: May 8, 2025

(54) A METHOD AND AN APPARATUS FOR ENCODING/DECODING A TEXTURED MESH

(71) Applicant: InterDigital CE Patent Holdings, SAS, Paris (FR)

(72) Inventors: Jean-Eudes Marvie, Betton (FR); Celine Guede, Cesson Sevigne (FR); Maja Krivokuca, Rennes (FR); Olivier Mocquard, Rennes (FR)

(21) Appl. No.: 18/835,424

(22) PCT Filed: Jan. 30, 2023
(86) PCT No.: PCT/EP2023/052118

§ 371 Date: Aug. 2, 2024

(30) Foreign Application Priority Data
Feb. 3, 2022 (EP) 22305118.6

(51) Int. Cl. G06T 9/00; G06T 7/10

(52) U.S. Cl. CPC G06T 9/001; G06T 7/10; G06T 2207/20021

(57) ABSTRACT

Methods and apparatuses for encoding or decoding animated textured meshes are provided wherein a texture map is encoded that comprises a regular grid of tiles, wherein each tile comprises texture data associated to a patch projected onto the tile, said patch belonging to partitioning of a surface of the texture mesh. According to an embodiment, the partitioning of the surface of the textured mesh is obtained by subdividing the surface of the mesh into a set of regular patches. According to an embodiment, encoding the texture map comprises arranging the tiles of the texture map based on an inter-tile transition cost. According to another embodiment, encoding the texture map comprises arranging the tiles of the texture map based on a distortion cost between the texture map of a reference frame and the texture map of the current frame.

### TECHNICAL FIELD

The present embodiments generally relate to a method and an apparatus for encoding and decoding of animated textured meshes, and more particularly encoding and decoding of 3D objects represented as meshes.

### BACKGROUND

Free viewpoint video can be implemented by capturing an animated model using a set of physical capture devices (video, infra-red, . . . ) spatially dispatched. The animated sequence that is captured can then be encoded and transmitted to a terminal for being played from any virtual viewpoint with six degrees of freedom (6 dof). Different approaches exist for encoding the animated model. For instance, the animated model can be represented as image/video, point cloud, or textured mesh.

In the Image/Video based approach, a set of video stream plus additional meta-data is stored and a warping or any other reprojection is performed to produce the image from the virtual viewpoint at playback. This solution requires heavy bandwidth and introduces many artefacts. In the point cloud approach, an animated 3D point cloud is reconstructed from the set of input animated images, thus leading to a more compact 3D model representation. The animated point cloud can then be projected on the planes of a volume wrapping the animated point cloud and the projected points (a.k.a. patches) encoded into a set of 2D coded video streams (e.g. using HEVC, AVC, VVC . . . ) for its delivery. However, the nature of the model is very limited in terms of spatial extension and some artefacts can appear, such as holes on the surface for closeup views.

In the textured mesh approach, an animated or time-varying textured mesh is reconstructed from the set of input animated/time-varying images. A feature of meshes is that geometry definition can be quite low and photometry texture atlas can be encoded in a standard video stream. Textured meshes encoding relies on texture coordinates (UVs) to perform a mapping of the texture image to the faces/triangles of the mesh.

### SUMMARY

According to an embodiment, a method for encoding at least one 3D object represented using a textured mesh or encoding at least one textured mesh is provided. Such a method comprises encoding a texture map comprising a regular grid of tiles, wherein each tile comprises texture data associated to a patch projected onto said tile, said patch belonging to a partitioning of a surface of the textured mesh.

According to another embodiment, an apparatus for encoding at least one 3D object represented using a textured mesh or encoding at least one textured mesh is provided. The apparatus comprises one or more processors configured to encode a texture map comprising a regular grid of tiles, wherein each tile comprises texture data associated to a patch projected onto said tile, said patch belonging to a partitioning of a surface of a textured mesh

According to a variant, UV coordinates are obtained on the regular grid of tiles for at least one patch of the textured mesh.

According to another embodiment, a method or an apparatus is provided for obtaining a partitioning of a surface of textured mesh wherein obtaining the partitioning comprises subdividing the surface of the mesh into a set of regular patches.

According to another embodiment, a method or an apparatus is provided for encoding a textured mesh whose texture is projected on a texture map having regular grid of tiles and wherein encoding the texture map comprises arranging the tiles of the texture map based on an inter-tile transitions cost.

According to another embodiment, a method or an apparatus is provided for encoding a textured mesh whose texture is projected on a texture map having regular grid of tiles and wherein encoding the texture map comprises arranging the tiles of the texture map based on a distortion cost between tiles of the texture map and tiles of a reference texture map.

According to another embodiment, a method for decoding at least one 3D object represented using a textured mesh or encoding at least one textured mesh is provided. The method comprises decoding a texture map comprising a regular grid of tiles, wherein each tile comprises texture data associated to a patch projected onto said tile, said patch belonging to a partitioning of a surface of a textured mesh.

According to another embodiment, an apparatus for decoding at least one 3D object represented using a textured mesh or encoding at least one textured mesh is provided. The apparatus comprises one or more processors configured to decode a texture map comprising a regular grid of tiles, wherein each tile comprises texture data associated to a patch projected onto said tile, said patch belonging to a partitioning of a surface of a textured mesh.

According to a variant, UV coordinates for the vertices of the textured mesh are decoded from a bitstream. According to another variant, UV coordinates for the vertices of the textured mesh are generated from decoded vertices and decoded topology of the textured mesh.

According to another embodiment, a bitstream comprising coded video data representative of a texture map comprising a regular grid of tiles, wherein each tile comprises texture data associated to a patch projected onto said tile, said patch belonging to a partitioning of a surface of a textured mesh.

One or more embodiments also provide a computer program comprising instructions which when executed by one or more processors cause the one or more processors to perform any one of the encoding method or decoding method according to any of the embodiments described above. One or more of the present embodiments also provide a computer readable storage medium having stored thereon instructions for encoding or decoding a textured mesh according to the methods described herein. One or more embodiments also provide a computer readable storage medium having stored thereon a bitstream generated according to the methods described herein. One or more embodiments also provide a method and apparatus for transmitting or receiving the bitstream generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates example of resulting texture frames obtained according to embodiments (the top row represents the original texture atlases, and the bottom rows represent the results after reprojection, tracking, padding).

FIG. 5 illustrates example of resulting texture frames obtained according to embodiments (the top row represents the original texture atlases, and the bottom row represents the results after reprojection, tracking, padding).

FIG. 6A illustrates an example of a method for encoding a textured mesh, according to an embodiment.

FIG. 6B illustrates an example of a method for encoding a textured mesh, according to another embodiment.

FIG. 7 illustrates an example of a method for encoding a textured mesh, according to another embodiment.

FIG. 8 illustrates an example of a method for encoding a textured mesh, according to another embodiment.

FIG. 9 illustrates an example of a method for decoding a textured mesh, according to an embodiment.

FIG. 10 illustrates an example of a method for decoding a textured mesh, according to another embodiment.

FIG. 11 illustrates examples of using distortion errors to compare sub-areas of images.

FIG. 12 illustrates an example of a method for encoding a textured mesh according to an embodiment.

FIG. 13 illustrates an example of a method for obtaining a texture map according to an embodiment.

FIG. 14 illustrates an example of a method for image-based tile tracking according to an embodiment.

FIG. 15 illustrates an example of a mesh graph.

FIG. 16 illustrates an example of a corresponding face graph construction.

FIG. 17 illustrates an example of a face graph.

FIG. 18 illustrates alternatives methods for determining weights for the face graph.

FIG. 19 illustrates a method for pre-processing the input mesh for the face graph generation.

FIG. 20 illustrates an example of generated segmentation of the surface without performing the optional refinement.

FIG. 21 illustrates an example of UV parametrization per patch/sub-mesh (top part) and a corresponding global UV parameterization including potential addition of empty row and column spaces between patches (bottom part), according to an embodiment.

FIG. 22 illustrates an example of spacing on a single patch, in image space, according to an embodiment.

FIG. 23 illustrates examples of texture atlases obtained according to an embodiment on a regular grid of tiles, using BFF UV generation with different modes, from left to right: 8 cones, disk and rectangle.

FIG. 24 illustrates texture map (left) reprojection into a controlled number of regularly sized tiles (center) according to an embodiment and a corresponding occupancy map (right) with 0 where no patch is projected and 1 where some patches are projected.

FIG. 25 illustrates example of dilation of patches, according to an embodiment.

FIG. 26 illustrates example of dilation on a re-projected atlas: (a) non dilated texture (left), and occupancy map (right), (b) dilated version of texture (left) and occupancy map (right) using the following parameters: dilationSize=10, borderSize=0, padding=off.

FIG. 27 illustrates an example of an intra-frame inter-tile gradients optimization according to an embodiment.

FIG. 28 illustrates an example of a generation of tile side reference pixel arrays (right) using simple pixel marching (left).

FIG. 29 illustrates an example of possible comparison of two patches' side reference pixel arrays using the MSE metric.

FIG. 30 illustrates an example of a method for image-based intra-frame tile re-organization, according to an embodiment.

FIG. 31 illustrates an example of inter re-organization on a frame 1 constrained by the intra re-organized frame 0 (the first frame of the GOP). Optional rotations and mirroring are not illustrated for the sake of simplicity. Not that the same process would apply for frame 2, but this time constrained by the inter re-organized frame 1 and so on until the end of the GOP.

FIG. 32 illustrates examples of different types of padding (b,c,d) applied to a tiled texture map (a).

FIG. 33 illustrates examples of topology issues, non-manifold edge (left), and non-manifold vertices (right).

FIG. 34 illustrates an example of a method for reprojecting the texture map, according to an embodiment.

FIG. 35 illustrates an example of a method for reprojecting a triangle, according to an embodiment.

FIG. 36 an example of a method for fetching source and destination triangles, according to an embodiment.

FIG. 37 illustrates an example of a method for reprojecting a pixel, according to an embodiment.

FIG. 38 shows two remote devices communicating over a communication network in accordance with an example of the present principles.

FIG. 39 shows the syntax of a signal in accordance with an example of the present principles.

FIG. 40 illustrates an embodiment of a method for transmitting a signal according to any one of the embodiments described above.

### DETAILED DESCRIPTION

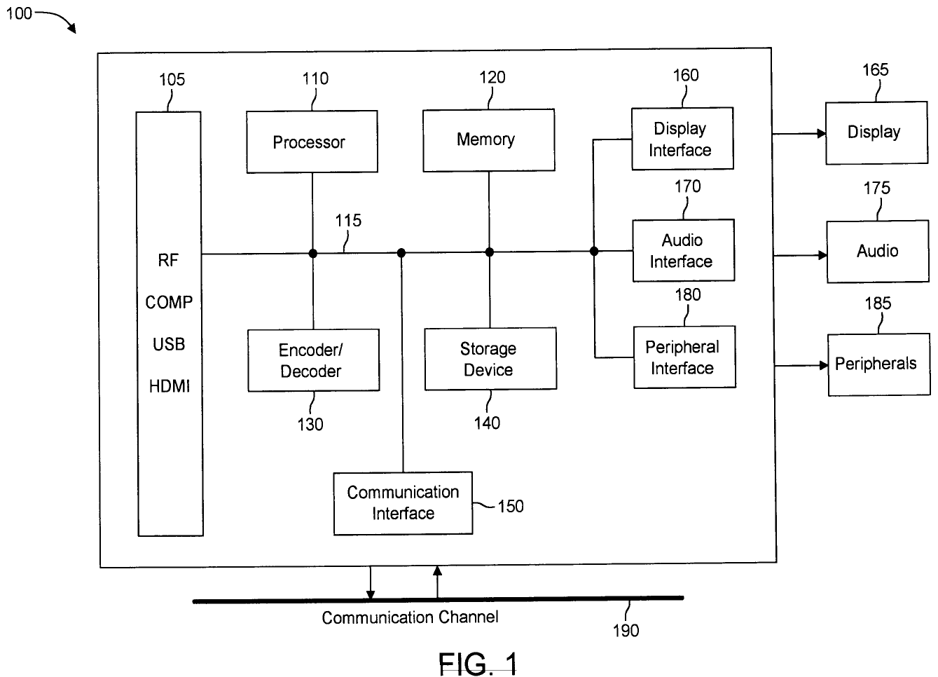

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video/3D object or decoded video/3D object, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video/3D object, the decoded video/3D object or portions of the decoded video/3D object, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for coding and decoding operations, such as for instance MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal. In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

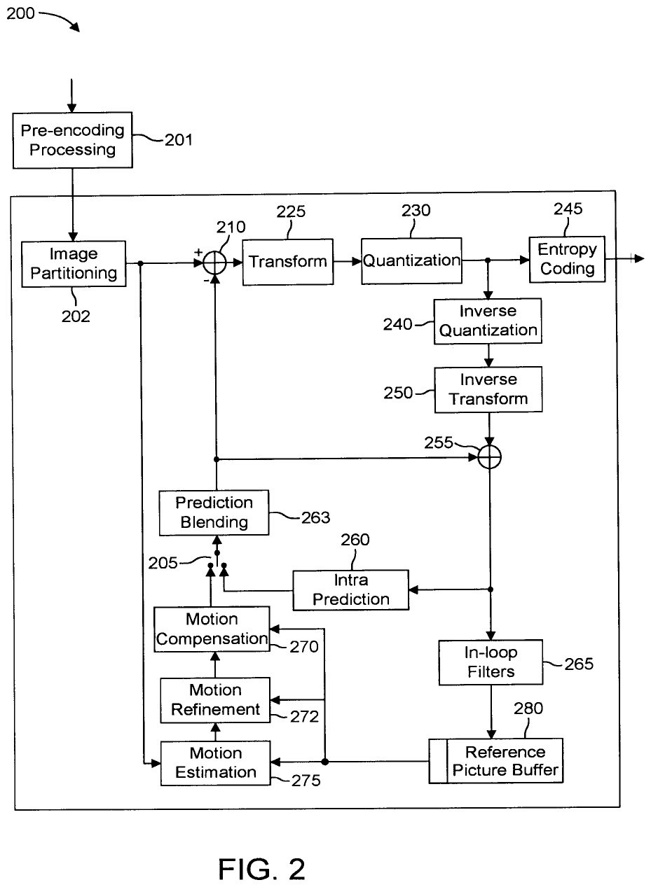

FIG. 2 illustrates an example video encoder 200, such as a High Efficiency Video Coding (HEVC) encoder, that can be used for encoding one or more attributes of an animated mesh according to an embodiment. FIG. 2 may also illustrate an encoder in which improvements are made to the HEVC standard or an encoder employing technologies similar to HEVC, such as a VVC (Versatile Video Coding) encoder under development by JVET (Joint Video Exploration Team).

In the present application, the terms “reconstructed” and “decoded” may be used interchangeably, the terms “encoded” or “coded” may be used interchangeably, the terms “pixel” or “sample” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods.

Prediction residuals are calculated, for example, by subtracting (210) the predicted block from the original image block. The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

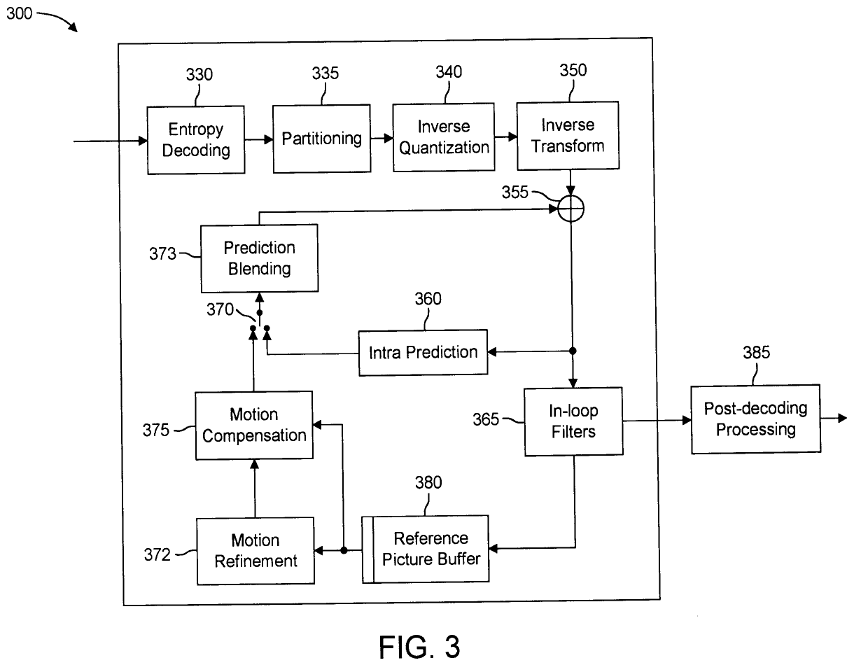

FIG. 3 illustrates a block diagram of an example video decoder 300, that can be used for decoding one or more attributes of an animated mesh according to an embodiment. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

The present application provides various embodiments for encoding/decoding at least one 3D object or an animated 3D object, i.e. a 3D object evolving over time, or a textured mesh, or a textured mesh with time-varying texture. According to an embodiment, the 3D object is represented as a point cloud or a 3D mesh. The following embodiments are described in the case of a 3D object represented as a 3D mesh. In some variants, the 3D mesh can be derived from a point cloud of the 3D object.

A mesh comprises at least the following features: a list of vertex positions, a topology defining the connection between the vertices, for instance a list of faces, and optionally photometric data, such as texture map or color values associated to vertices. The faces defined by connected vertices can be triangle or any other possible forms. For easiest encoding, the photometric data is often projected on texture map so that the texture map can be encoded as video image.

According to an embodiment, a method for time varying textured mesh lossy compression is provided. Time varying meshes are meshes where attributes and topology can vary at each frame. Note however that the embodiments presented herein also apply to meshes where the topology stays unchanged for some frames over the entire sequence.

When coding a mesh with texture maps, one also needs to encode the texture UV coordinates used to map the image texture onto the mesh surface. Storing these UV coordinates can consume a lot of storage space and can be more complex to encode than the vertex positions due to their stronger variability. Therefore, providing a solution that permits to encode the mesh without its UV coordinates but still allows to decode the mesh with UV coordinates is a strong added value for a mesh codec. An embodiment of a method for encoding a textured mesh is provided wherein UV coordinates are not encoded but regenerated at the decoder side.

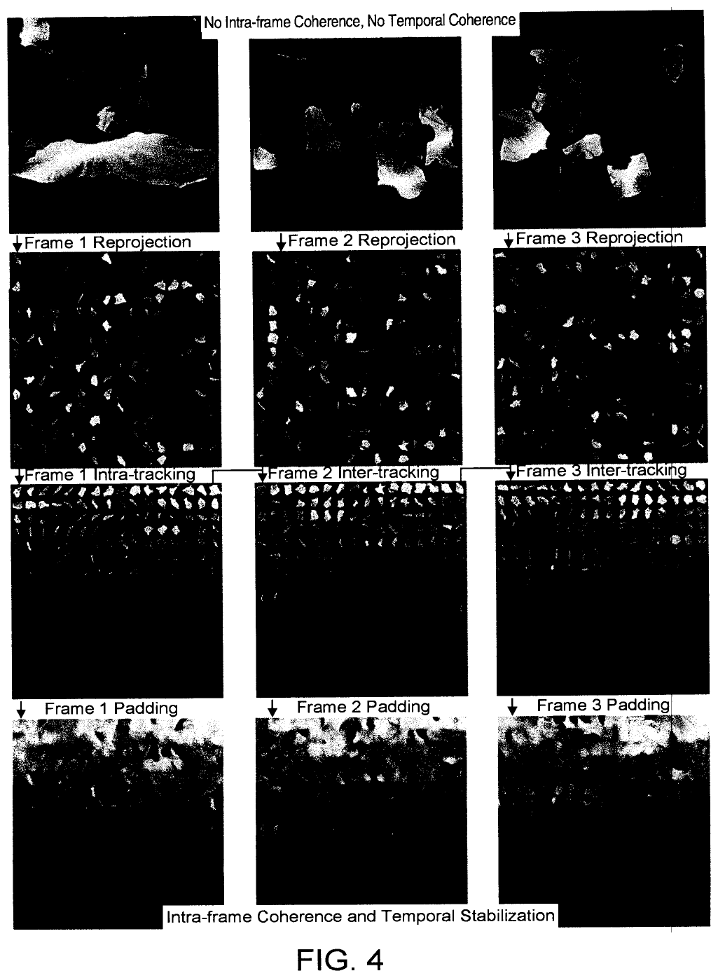

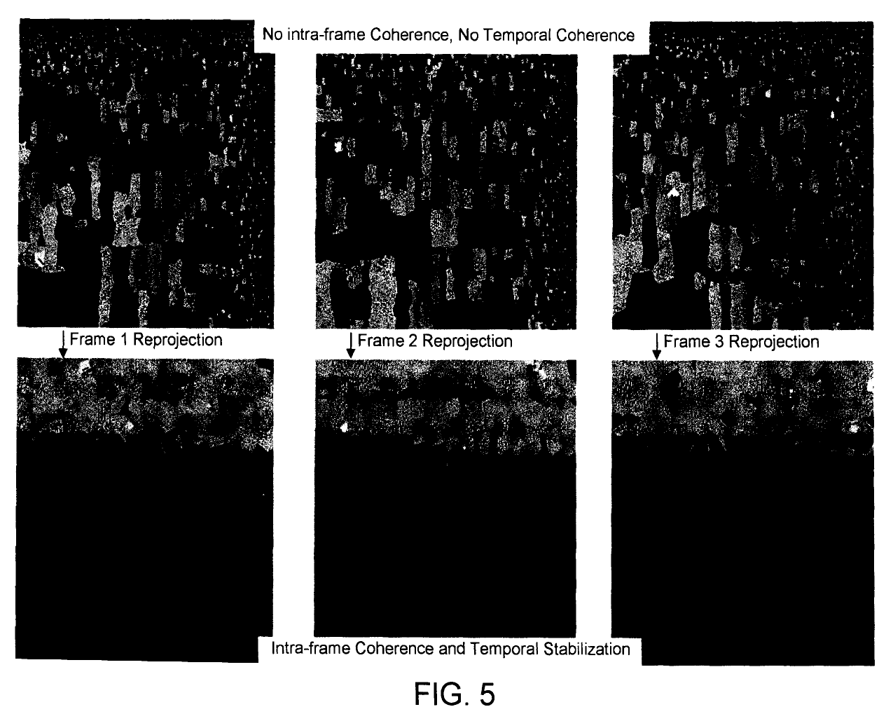

Any texture atlas generator can be used to generate the UV coordinates. But, with most atlas generators the output texture map frames are not optimal for encoding with standard video encoders. Indeed, since the atlas generator generally relies on the mesh topology, and since the mesh topology changes at each frame, atlas generators often produce poor inter-frame stability. They also usually generate poor intra-frame smoothness due to crude inter-patch transitions. Top rows of FIG. 4 and FIG. 5 illustrate examples of animated texture frame instability on models obtained with two different types of atlas generators, i.e. different UV parameterization.

According to an embodiment, a method for encoding/decoding a textured mesh is provided wherein stabilized texture maps are obtained. Stabilized texture maps can be obtained by mesh tracking (also named mesh registration) that regenerates a coherent topology over time. However, this kind of transformation is a costly operation, and it also introduces noise at the geometry level (remeshing) and at the texture map level (reprojection).

According to an embodiment, a method for encoding/decoding a textured mesh is provided wherein UV atlases are generated such that they naturally permit associated reprojected texture maps to be spatially and temporally correlated to obtain higher compression rates when coding the animated texture maps using a video coder such as HEVC or VVC for instance.

Rather than performing a tracking of the mesh, in some embodiments, a non-degrading subdivision of the mesh into patches of approximately equal size and area is used. New UV coordinates are then generated individually for each patch. This operation leads to texture UV atlases made of tiles of similar size, containing for each tile the reprojected part of the original texture (as illustrated on FIGS. 4 and 5).

In an embodiment, once the tile atlases are obtained for each frame, a reorganization of the tiles of the first frame of each group of pictures (GOP, as commonly used in video compression) is performed to optimize intra-frame tile transitions by minimizing gradients (transitions in color between tiles) with a greedy algorithm. This allows to improve compression efficiency of the texture map.

In an embodiment, for time-varying textured mesh, each subsequent frame of the GOP is tracked relatively to the previous frame using image-based distance (difference) computations based on an image metric (for instance an MSE).

At the end of the process, a set of meshes is obtained whose topology is left unchanged, but the UV coordinates are changed to parameterize a set of stabilized tiled texture atlases that are more suitable for compression than the original texture atlases. FIG. 4 and FIG. 5 illustrate examples of animated texture frames once stabilized according to the embodiments cited above.

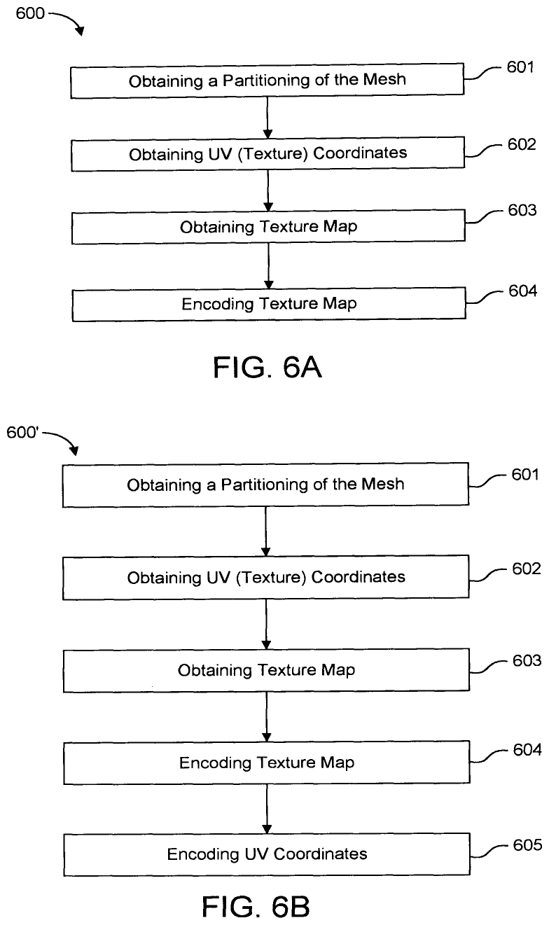

According to an embodiment, a method 600 for encoding a textured mesh is described in relation with FIG. 6A. An input textured mesh is provided as input to the process. For instance, the input textured mesh is representative of a 3D object, that can evolve over time. The input textured mesh comprises a set of vertices, each vertex having input UV coordinates indicating for the vertex a texture location in an input texture map provided with the input mesh.

At 601, a partitioning of a surface of the input mesh is obtained. The surface of the mesh is partitioned into a set of patches wherein the patches have approximately equal area and size.

The patches comprise faces of the original mesh, patches are sub-meshes of the original mesh and have a bounded area and 3D size such that their texture can be projected on tiles of a same size in the texture map.

Embodiments for obtaining the partitioning are described further below. At 602, UV coordinates are obtained such that the UV coordinates corresponds to texture coordinates of vertices of the mesh on a regular grid of tiles. At 603, a texture map is obtained by projecting the input texture map on the regular grid of tiles using input UV coordinates of vertices of the textured mesh and the UV coordinates obtained at 602. Each tile of the texture map comprises texture data associated to a patch of the partitioning projected onto the tile. At 604, the texture map that comprises the regular grid of tiles is encoded, for instance as an image of a video coder. As can be seen below, in some embodiments, further processing of the texture map can be done to improve compression efficiency. In this embodiment, attributes of the mesh are also coded in a bitstream with the texture map, such as the topology and vertices positions. In this way, the textured mesh can be processed at the decoder, for instance rendered. However, it is to be noted that in this embodiment, no UV coordinates are coded in the bitstream. The UV coordinates that have been obtained at 602 are generated on the decoder side in a similar manner as is done at 602. It is to be noted also, that when generating the UV coordinates at 602, the generation process uses decoded attributes of the mesh rather than original attributes of the mesh in order to take into account of compression losses.

FIG. 6B illustrates an example of a method 600′ for encoding a textured mesh, according to another embodiment. This embodiment is similar to the one described in relation with FIG. 6A. However, in this embodiment the UV coordinates obtained at 602 are coded in the bitstream at 605 with the texture map and the other attributes of the mesh.

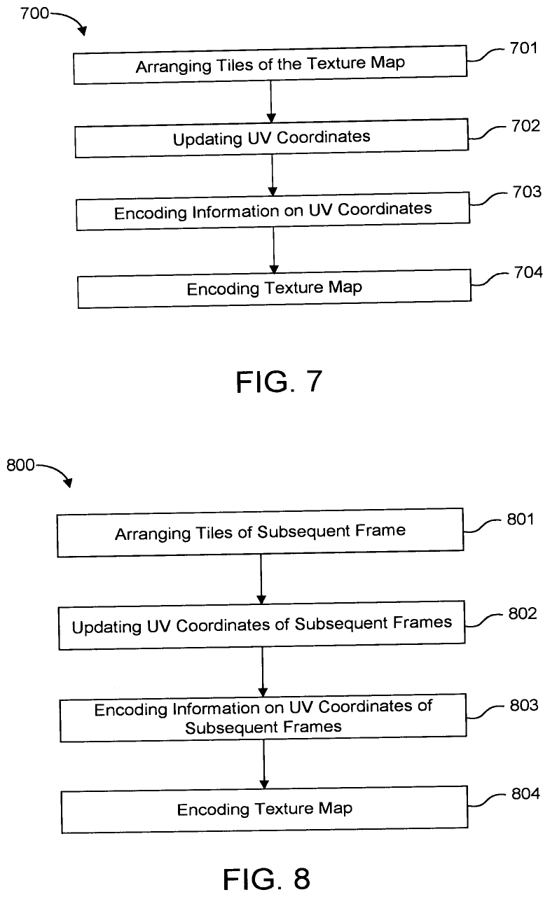

FIG. 7 illustrates an example of a method 700 for encoding a textured mesh, according to another embodiment. In this embodiment, the texture map that comprises the texture data of the input textured mesh comprises a regular grid of tiles, wherein each tile comprises the texture data associated to a patch of the mesh projected onto the tile, said patch belonging to a partitioning of a surface of the textured mesh. According to the embodiment, at 701, the tiles of the texture map are arranged so as to reduce the cost for coding the texture map as an image. This arrangement can be done for instance by minimizing an inter-tiles transition cost. At 702, the UV coordinates associated to the vertices of the mesh are updated based on the arrangement of the tiles. At 703, information on the UV coordinates is coded in a bitstream. In a variant, the updated UV coordinates are coded. In another variant, only an information for updating the UV coordinates is coded so that at the decoder, the UV coordinates are generated, and then updated using the decoded information. At 704, the newly arranged texture map is coded in the bitstream. Other attributes of the mesh can also be coded in the bitstream.

FIG. 8 illustrates an example of a method 800 for encoding a textured mesh, according to another embodiment. In this embodiment, it is assumed that the textured mesh is a time-varying textured mesh. Therefore, the textured mesh comprises two or more frames: a first texture map corresponds to texture data of a first frame of the textured mesh. In a variant, the first texture mesh can be arranged in a similar manner as described with FIG. 7. In the embodiment of FIG. 8, arrangement of the subsequent frames (frames other than the first frames) is considered.

At 801, the tiles of the texture map of a subsequent frame are arranged so as to reduce the cost for coding the texture map of the subsequent frame. This arrangement can be done for instance by minimizing a distortion cost between the texture map of the subsequent frame and a texture map of a reference frame, for instance the first frame or a previous frame.

At 802, the UV coordinates for the texture map of the subsequent frame are updated based on the arrangement of the tiles done at 801. At 803, information on the UV coordinates is coded in a bitstream. In a variant, the updated UV coordinates are directly coded. In another variant, an information for updating the UV coordinates is coded, so that at the decoder, the UV coordinates are generated, and then updated using the decoded information. At 804, the newly arranged texture map of the subsequent frame is coded in the bitstream. Other attributes of the mesh can also be coded in the bitstream.

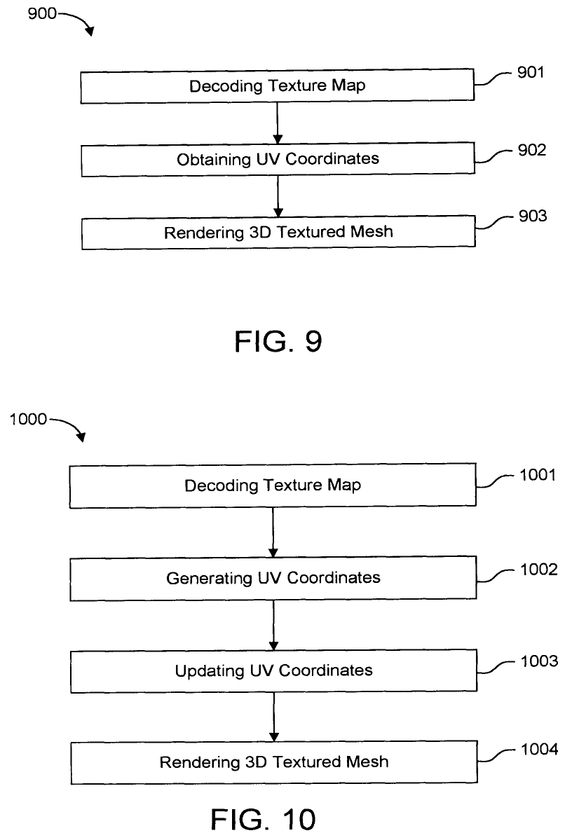

FIG. 9 illustrates an example of a method 900 for decoding a textured mesh, according to an embodiment. A bitstream is received that comprises coded data representative of attributes of the textured mesh and an associated texture map. At 901, the texture map is decoded. According to the principle described herein, the texture map comprises a regular grid of tiles, wherein each tile comprises texture data associated to a patch projected onto said tile, said patch belonging to a partitioning of a surface of the textured mesh. Attributes of the mesh are also decoded.

At 902, UV coordinates on the regular grid of tiles are obtained for each vertex of the mesh. In a variant, the UV coordinates are obtained by decoding the attributes from the bitstream. In another variant, the UV coordinates are generated from the decoded vertices positions. At 903, the textured mesh comprising the decoded or generated attributes and the decoded texture map is available for any kind of processing, such as rendering for instance.

FIG. 10 illustrates an example of a method 1000 for decoding a textured mesh, according to another embodiment. At 1001, texture map and attributes of the mesh are decoded as in the embodiment above. At 1002, the UV coordinates are generated from the decoded attributes. At 1003, information for updating the UV coordinates is decoded from the bitstream. The UV coordinates are then updated using the decoded information. As described in some embodiments above, the tiles of the texture map could be the result of an arrangement intra-image or inter-image, i.e. with respect to a reference texture map. Thus, since in this embodiment, the UV coordinates are not decoded but rather generated from the decoded attributes, the UV coordinates are updated so as to take into account the arrangement of the tiles that could have occurred before coding the texture map. At 1004, the textured mesh is available for any kind of processing, for instance to be rendered as in the embodiment illustrated with FIG. 9.

Any one of the embodiments described herein for coding or decoding a textured mesh can be used in combination with any one of the other embodiments for coding or decoding a textured mesh. Detailed embodiments are described below.

### Mathematic and Algorithmic Tools

Some mathematical and algorithmic tools are presented below.

Dijkstra shortest path algorithm: Dijkstra's algorithm is an algorithm for finding the shortest paths between nodes in a graph, which may represent, for example, road networks. The algorithm exists in many variants. Dijkstra's original algorithm finds the shortest path between two given nodes, but a more common variant fixes a single node as the “source” node and finds shortest paths from the source to all other nodes in the graph, producing a shortest-path tree.”

In some embodiments described herein, a variant of Dijkstra's algorithm is used that gives for one vertex vₙ of a graph G all the shortest paths to all the other vertices v_{i,i≠n} of the graph. A simple graph representation is used where vertices vᵢ are indices i in [symbol] ⁺ and where each existing edge e_{j,k} is assigned a weight w_{j,k} that is a value in [symbol] ⁺. The function is noted as follows:

(D,P)=Dijkstra(G,vₙ)

which returns for each vertex vᵢ the distance d in terms of summed weights over the shortest path from vₙ to vᵢ, and the result is stored in an association table noted D. It also returns the exact path as a set of vertices for each pair (vₙ, vᵢ) in an association table noted P. Then Dᵢ denotes the shortest distance from on to vᵢ, and Pᵢ is a sequence of vertex indices that describes the path from vₙ to vᵢ. If a path is empty because of non-connected vertices (vₙ, vᵢ) the distance Dᵢ is set to infinite. Self-distance vₙ to vₙ is always equal to zero.

Mean Squared Error (MSE): The calculation of a 2D image distortion using Mean Squared Error (MSE) is given by the following formula. Let Y_{i,j} be a sample (pixel color value) of an original image, Ŷ_{i,j} the corresponding sample (pixel color value) of a distorted image, w the width and h the height of both images in pixels. The MSE for the two images is calculated as follows:

$$MSE ( w , h ) = \frac{1}{w \cdot h} {\sum }_{i = 0}^{w - 1} {\sum }_{j = 0}^{h - 1} {( {Y}_{i , j} - {\hat{Y}}_{i , j} )}^{2}$$

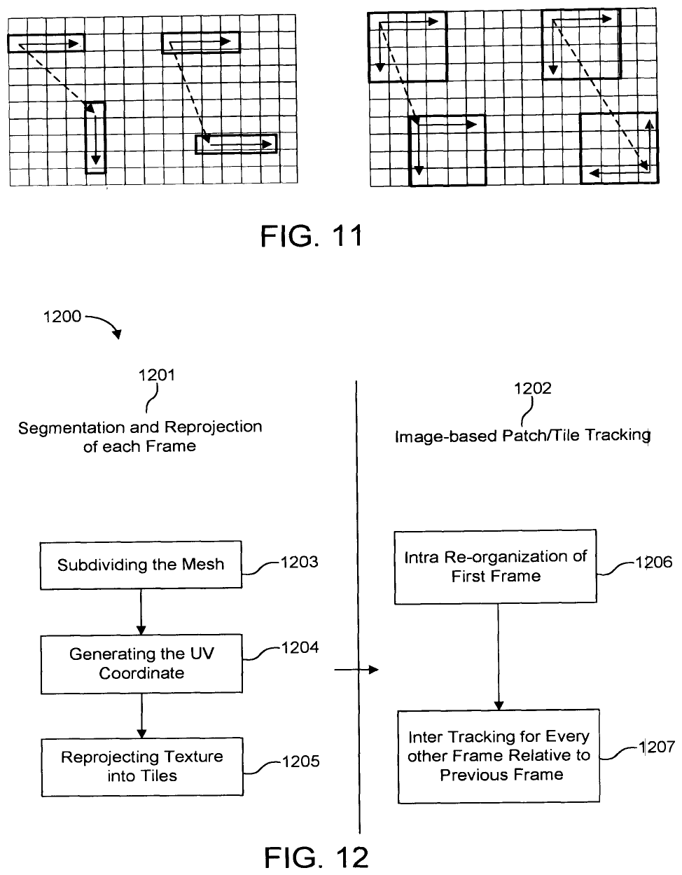

By specializing the formulation above, one can easily obtain some functions to compare two sub-images, two sub-lines, two sub-columns or one sub-line and one sub-column located at different places of one or two different images (see FIG. 11). These functions can also handle rotation or mirroring of one or both sub-areas to compare.

FIG. 11 illustrates examples of using distortions metrics to compare sub-areas of images, for instance using the MSE discussed above, but other metrics can be used. From left to right: comparing a horizontal line with a vertical line, comparing a horizontal line with a horizontal line, comparing two blocks, and comparing a block with a mirrored block. Note that lines could also be mirrored. Note that the two zones that are being compared can be in separate images or in the same image.

FIG. 12 illustrates an example of a method 1200 for encoding a textured mesh according to an embodiment. Each frame of the mesh is first segmented to generate new tiled UV atlases and the texture map is reprojected onto a new tiled texture map. In a second part, the generated tile atlases are re-organized to achieve higher compression rates when coding the texture atlases of the frames using a video coder. Thus, the method 1200 comprises two stages: a stage 1201 for obtaining the texture map having a regular grid of tiles and a stage 1202 for re-organizing the texture map for compression efficiency.

At 1201, a segmentation and reprojection of each frame is performed. This stage comprises at 1203 a subdividing of the input mesh into patches as regular as possible. At 1204, for each patch, the UV coordinates are generated. At 1205, the input texture map is reprojected into the tiles of the regular grids.

At 1202, image-based patch/tile tracking is performed. For that, at 1206, an intra re-organization of the first frame is done. In a variant, this intra re-organization can be done for each frame of the sequence or GOP. In another variant, for subsequent frames of the group of frames, at 1207, inter tracking is performed for every other frame relative to a reference frame. Depending on variants, the reference frame can be the first frame of the GOP, or a previously tracked frame of the GOP.

Below, some embodiments of the steps described above are presented.

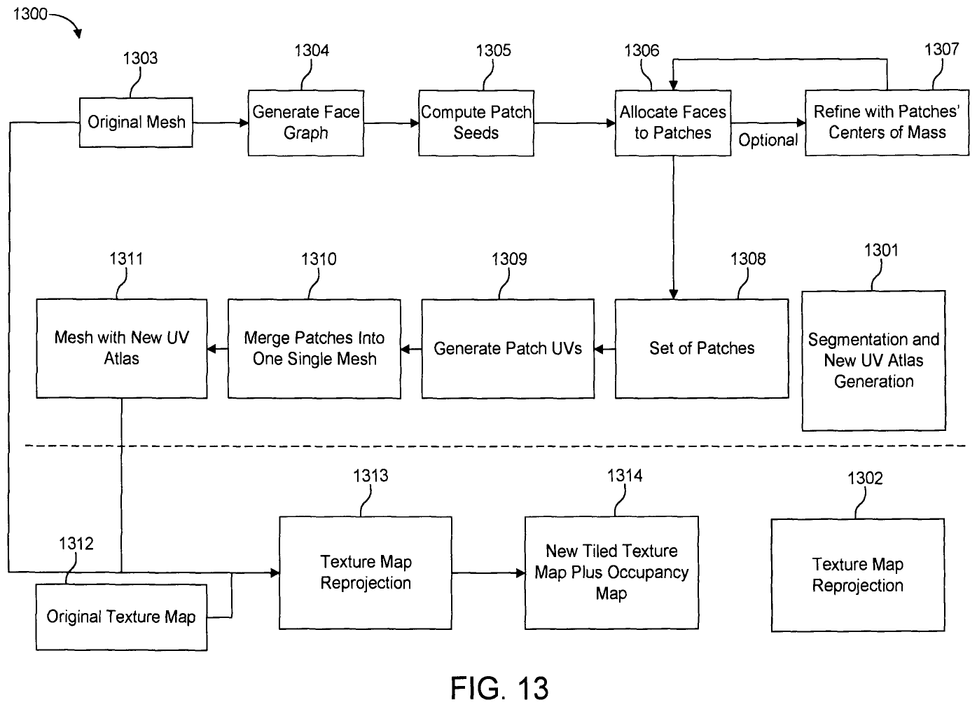

FIG. 13 illustrates an example of a method 1300 for obtaining a texture map according to an embodiment. A segmentation of an input mesh and texture reprojection is performed for each frame. In a first stage (1301), the mesh associated with each frame is segmented to generate a partition of its surface. This partition is then used to generate (1302) new texture coordinates for the mesh (UV atlas) composed of regular UV patches, each one fitting into a square UV sub-space. This new UV atlas is then used to reproject the original texture map, associated with the mesh, into a new texture map made of tiles as can be seen in the example in the second row of FIG. 4.

Method 1300 takes as input an input (original) mesh 1303 with vertex positions, topology, texture UV coordinates and faces barycenter, and is associated with an original texture map 1312 than can have been obtained by any method. At 1304, a face graph is generated from the input mesh. At 1305, patch seeds are determined and at 1306, other faces are allocated to patches. In a variant, at 1307, a refinement can be performed using patches center of mass. At the end of the segmentation, a set of patches (1308) is obtained that comprises one mesh per patch, the topology and vertex positions, but no texture UV coordinates. So, at 1309, UV coordinates are generated for each patch. This could be done using any known methods as is described below. At 13010, the patches are merged into one single mesh so as to obtain (1311) a mesh with new UV atlas. This mesh comprises the same vertex positions, same face set, same faces barycenter as the input mesh, but with an updated topology and new texture UV coordinates. At 1313, the original texture map is reprojected to obtain the new texture map that corresponds to the new texture UV coordinates. Thus, a new tiled texture map is obtained at 1314. In a variant, an occupancy map is also obtained to identify the locations in the tiled texture map that are occupied.

Face Graph Generation (step 1304):

The triangle graph (or face graph) generation principle is based on [4] (2002—Metamorphosis of Polyhedral Surfaces using Decomposition. Shymon Shlafman and Ayellet Tal and Sagi Katz Comput. Graph. Forum, 219-228) in which according to the embodiment described herein the weight computation is modified and a mesh pre-processing step is added.

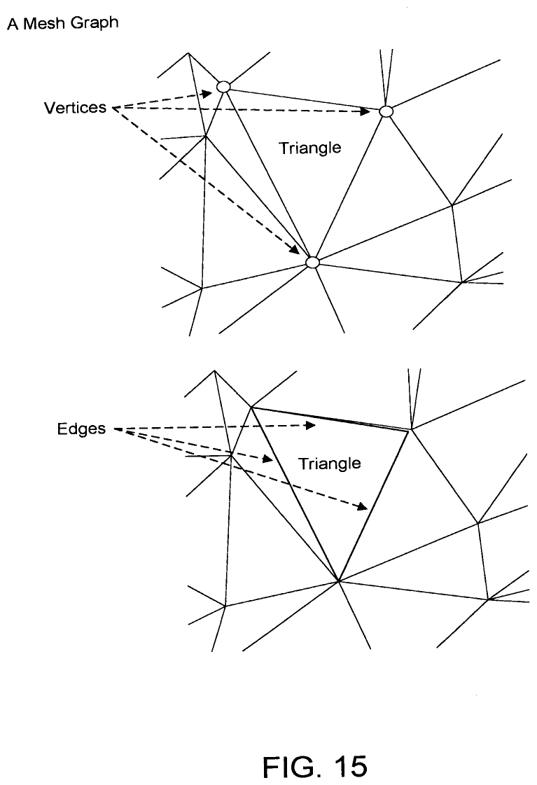

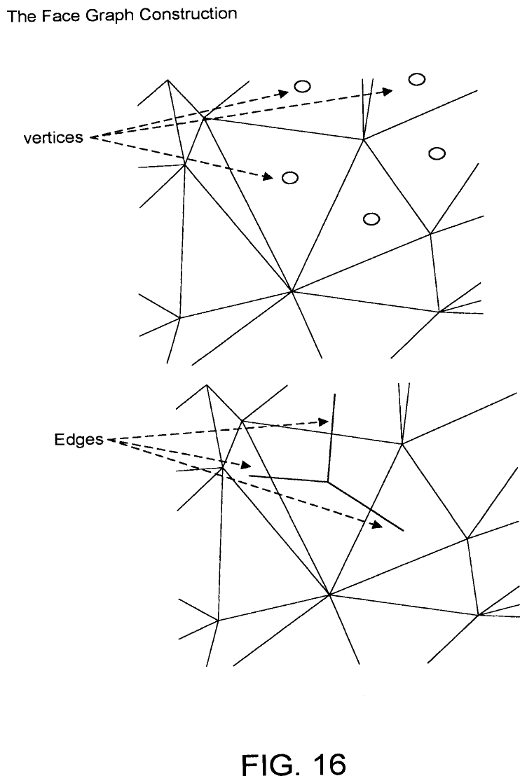

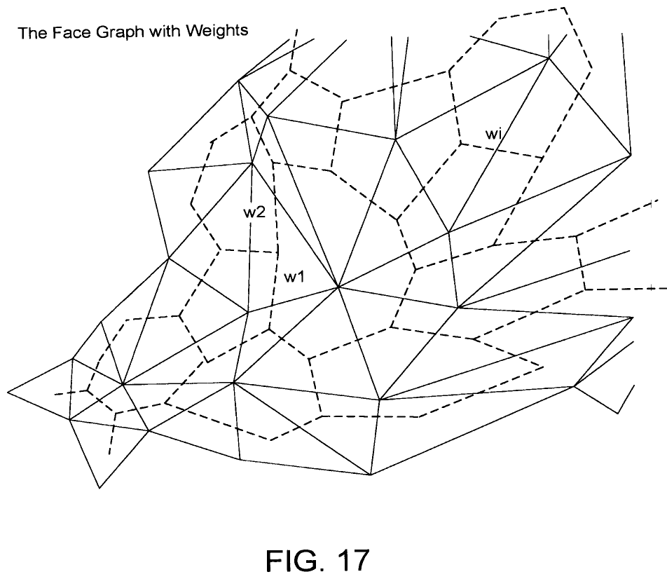

Definition: The face graph is a partial dual graph (see FIG. 15-16) of the mesh graph where triangles are connected by their edges (FIG. 15). In the corresponding face graph (FIG. 16):
A vertex of the face graph is the index of the face in the original mesh
An edge of the face graph is created between two faces whenever they are connected by their edge in the original mesh
The face graph is just topology information; the vertices of the graph do not need to have a position in space even if it can be considered to attach the face barycenter to these vertices, this is not what is done here. Weights associated with each edge of the face graph w1, w2, . . . wi are used, as illustrated on FIG. 17. On FIG. 17, the dotted lines represent the edges of the face graph. Each edge of the face graph gets a weight w that represents a distance between the two triangles connected by the face graph edge.

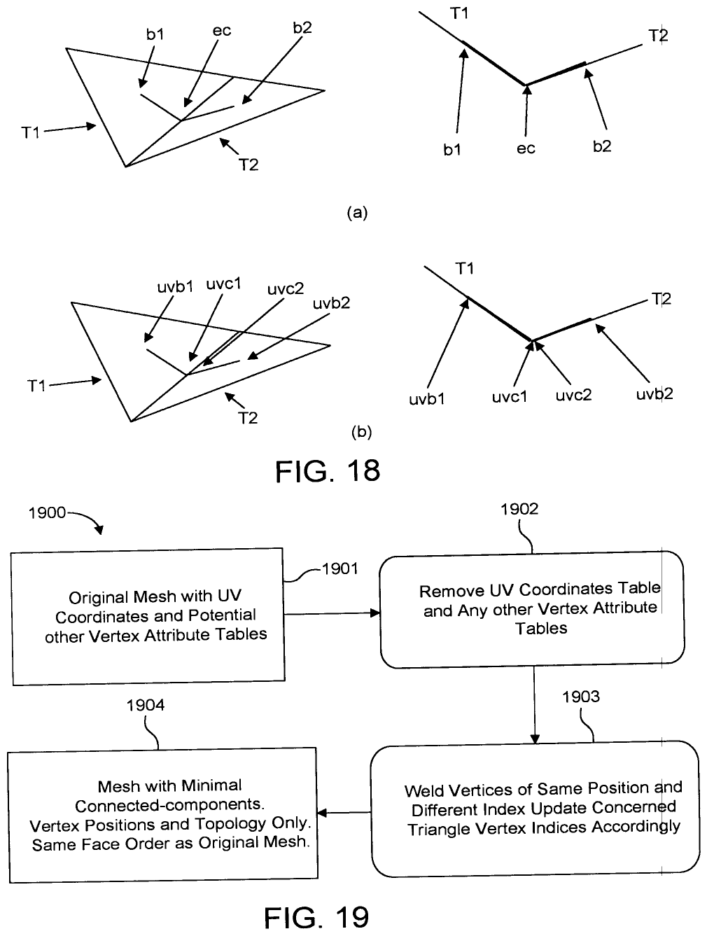

The determination of the weight for two adjacent triangles T1 and T2 is depicted in FIG. 18 (a). Let b1 be the barycenter of T1, b2 the barycenter of T2 and ec the center of the edge common to T1 and T2. Then the weight w for the face graph edge connecting T1 and T2 (a.k.a. the distance on the surface between T1 and T2) is computed as follows:

$$w = euclideanDistance ( b 1 , ec ) + euclideanDistance ( ec , b 2 )$$

It is to be noted that as in [4] additional constraints could be added at the w computation level such as the angle between faces, etc. However, the formula above is efficient for the present embodiment in terms of obtained shapes.

Alternative determination of the weight. The previous weight determination is efficient if the original texture map and texture atlas have a uniform mapping density. In counterpart, if some large triangles have few texture samples allocated and other small ones have many samples allocated, the UV atlas is not uniform, but the patches generated with the previous weight computation would imply a uniform reprojection. To circumvent this issue, the weight is determined by using distances in UV space rather than in 3D model space. This alternative is illustrated in FIG. 18(b). Since two faces can share an edge on a texture seam (i.e., when each face is mapped to a different patch), the edge common to both faces can have different UV coordinates for each face. This explains the use of two UV center points: uvc1 and wvc2. Let uvb1 be the UV coordinate associated with b1, uvb2 the UV coordinate associated with b2, uvc1 the UV coordinate associated with ec for triangle T1 and wvc2 the UV coordinate associated with ec for triangle T2. The computation of the alternative weight w′ is then performed as follows:

$${w}^{′} = euclideanDistance ( uvb 1 , uvc 1 ) + euclodeanDistance ( uvc 2 , uvb 2 )$$

Then, the distance between two non-sibling triangles Tm, Tn is the sum of the weights (using w or w′ depending on a user's choice) of the edges found by the Dijkstra algorithm to connect Tm and Tn with the shortest path on the face graph. This is thus directly the output of the Dijkstra algorithm presented above.

A method 1900 for Mesh pre-processing is presented in relation with FIG. 19. When the input mesh comes with UV coordinates, this leads naturally to an original mesh topology with several connected components: one connected component per original UV patch. However, the method described below for the segmentation works on a per connected component basis. Since a new surface segmentation is generated where generated patches would not necessarily be smaller or equal to the existing patches, the original mesh (1901) is pre-processed by removing (1902) the UV coordinates and welding (1903) the vertices that have the same positions but different UV coordinates. The concerned triangle vertex indices are updated accordingly. This leads to a new mesh (1904) with the same set of triangles, enumerated in the same order (so that the original UV coordinates for a given triangle of the new mesh can still be found), possibly with different vertex indices, but with a minimal set of connected components (the ones related to the geometry due to two separated objects and not the ones related to the UV coordinates). Thanks to this, when the patches are generated using the face graph, new patches are generated that are larger than the original patches (i.e., that can span over several original patch boundaries). For instance, an original texture atlas made up of a high number of tiny patches like the ones in FIG. 5, can be transformed into an atlas with fewer patches made by an aggregation of original patches.

### Mesh Segmentation (a.k.a Patches Generation, Steps 1304, 1305, 1306, 1307 of FIG. 13):

The mesh segmentation principle is based on [4], to which a modification is added. With this algorithm, a segmentation of the mesh surface into a set of sub-meshes (or “patches”) of approximately equal area and average size is obtained. An additional strong point of this algorithm is that a given number of patches to obtain can be set. This provides an advantage since these patches' UV atlases can be sorted and dispatched into a regular grid of tiles. The idea is to select a set of faces (“seeds”) on the surface such that inter-seed distances are maximized, then to allocate other faces of the mesh to their nearest seed to construct one patch per seed. Thus, a patch comprises the face-seed and its allocated faces.

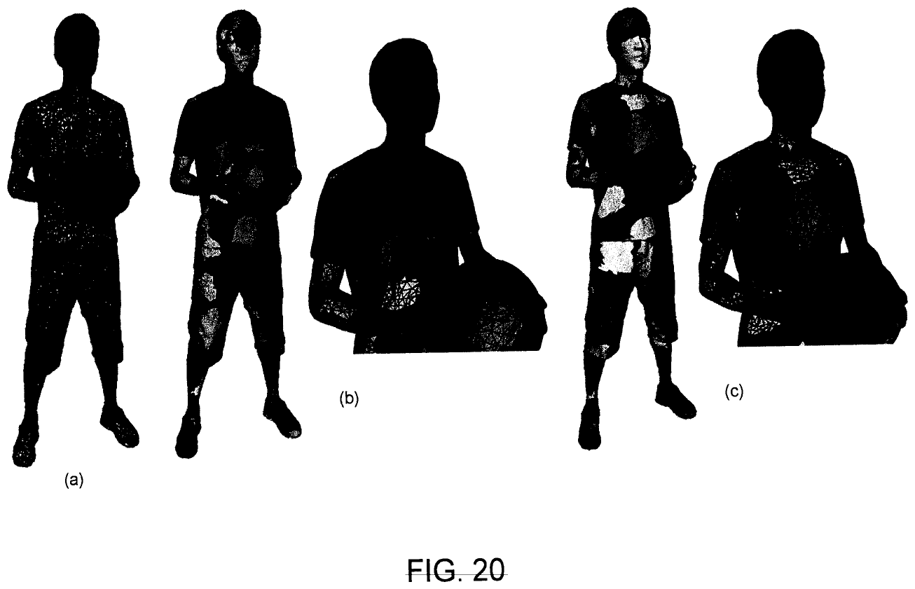

In the embodiment described herein, the face seeds are selected differently from [4]. In [4], a new representative is added so as to maximize the average distance to all the existing representatives on the same connected component, with representative meaning seed. However, this leads to non-uniform patches. Therefore, in the present embodiment, a new representative/seed is added to maximize the minimal distance to all the existing representatives on the same connected component. It is to be noted that we could also use average distance as an alternative. FIG. 20 gives an example of the resulting segmentation according to this embodiment: (A) illustrates an original mesh unsegmented, (b) shows a subdivided mesh using weight w in 3D model space, one color per patch for visualization, and (c) shows a subdivided mesh using weight w′ in UV space, one color per patch for visualization. It is to be noted that the same number of patches are generated for both (b) and (c).

The algorithm consists in the following steps:
First seed selection
Other seeds selection
Allocate faces to patches
Optional refinement to refine patches

The input of the algorithm is:
the pre-processed mesh with minimal number of connected components
the face graph associated with this mesh
a table containing the center of mass of each triangle
the center of mass of the pre-processed mesh (i.e., of its vertices having the same weights)
the target number of patches

As described with FIG. 13 (step 1305), patches seeds are first determined. In a variant, the first seed is selected by taking the triangle whose center of mass is nearest to the mesh's center of mass. This prevents a random choice. Then, other seeds are selected as follows:
Until a target number of seeds is reached do:
Select a face whose distance to all the already selected seeds is maximal
For all faces not already selected as seeds do:
compute the distance from the face to all the previously selected seeds using Dijkstra and store the minimal distance associated with the face.
Select the face with the maximal distance value (computed above) as the new seed.

When determining the other seeds, all the distances computed using Dijkstra are also stored to prevent re-processing those in the next step. An association table is thus obtained that, for each seed, contains the Dijkstra distance from all the other faces to the seed.

Remaining faces are allocated to patches (step 1306 of FIG. 13). This allocation uses the pre-computed Dijkstra distances to allocate unselected faces to their respective patches by selecting the patch associated with the seed of closest distance to the face.

An optional refinement can then be performed at 1307 of FIG. 13. The refinement consists in selecting for each patch a new seed amongst its faces that is closest to the center of mass of the patch. Once new seeds are found for all patches, the allocating step 1306 is re-run and this is done until stability is reached (i.e., until new seed computation starts to produce the same set of seeds as in the previous iteration) or until a certain number of iterations is reached.

### UV Atlas Generation.

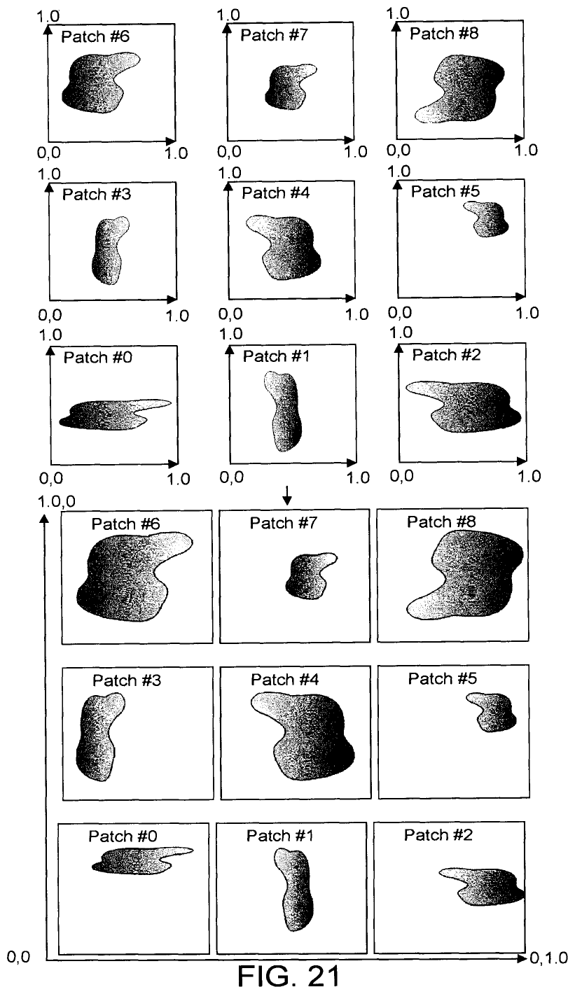

Once the patches are generated, a list of sub-meshes (a patch is a sub-mesh) is obtained (1308 in FIG. 13). For each of these sub-meshes, a new local UV parameterization is determined (step 1309 of FIG. 13). Computing such a parameterization is simpler than for the complete mesh since each sub-mesh is much smaller. In one embodiment, the new UV coordinates for each patch are generated using the BFF method described in [1] (2018—Boundary First Flattening, Rohan Sawhney and Keenan Crane, ACM Trans.Graph. 5:1-5:14). It is to be noted that several other solutions such as [2] (2004—A Fast and Simple Stretch—Minimizing Mesh Parameterization. Shin Yoshizawa 0001 and Alexander G. Belyaev and Hans-Peter Seidel Proceedings Shape Modeling Applications, 2004., 200-208), or [3] (2002—Least squares conformal maps for automatic texture atlas generation. Bruno Lévy and Sylvain Petitjean and Nicolas Ray and Jérôme Maillot. ACM Trans. Graph., 362-371), could be used but might require additional pre-processing of the patch mesh to work. At the end of this process, for each patch, a UV parameterization is obtained with UV coordinates set between 0.0 and 1.0 in each axis direction u and v (part of FIG. 21).

Once the individual UV spaces are generated for patches, they are transformed into a global UV coordinate system (step 1310 of FIG. 13, bottom part of FIG. 21) using scaling and translation of local patch UV coordinates (top part of FIG. 21). To organize the patches in the global coordinate system, the patches are taken in the order they are generated by the segmentation process. Note that the order of the patches is not critical at this step of the process since, in one embodiment, image tiles will later be re-ordered using an image-based mechanism.

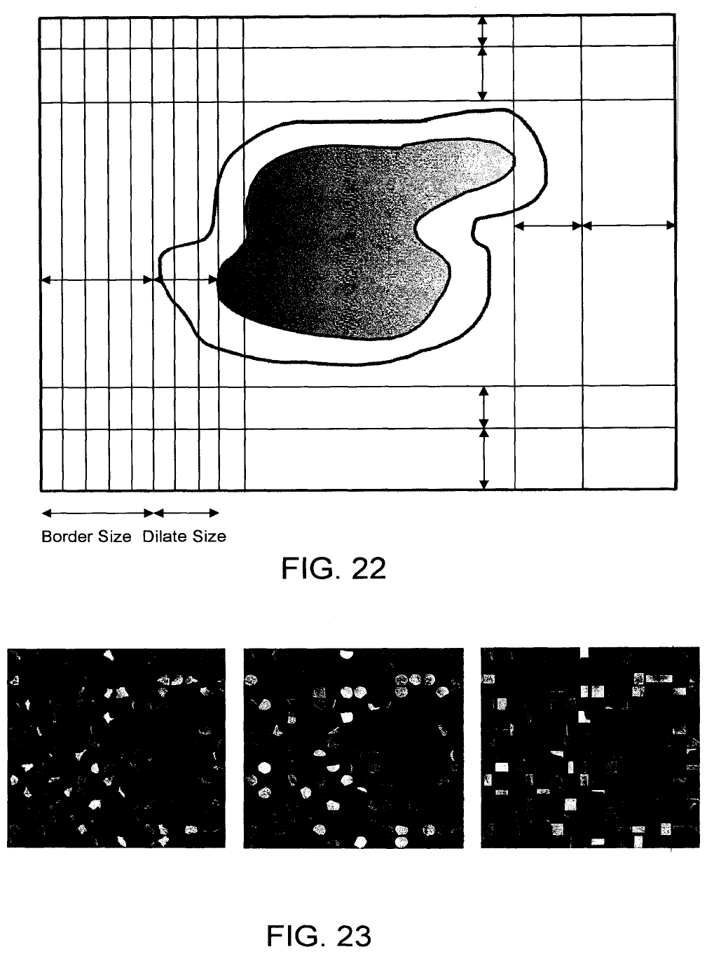

During the process of UV transformation, according to a variant, that is optional, some spacing between tiles is added. The spacing is determined as a function of a target number of pixels that separate each tile in the final re-projection (spacing=dilateSize+bordersize, see FIG. 22).

Inputs of the method for generating the UVs are the following:
patches: vector of patches, each patch without UV coordinates
mapWidth: integer representing the size of the output texture map (considered square for symplicity, but could be rectangle)
dilateSize: integer representing the dilatation size in pixels
borderSize: integer representing the size of borders around the tile for better padding (in pixels)
bffFlattenMode: BFF method to compute UVs (can be disk, cones, or rectangular)

Variables of the method for generating the UVs are the following:
gridRes: integer representing the number of tiles per row and per column (side of the grid)
tileSize: integer representing the size of each tile
utilSize: integer representing the size of the output image occupied by tiles
utilUvSize: real number representing the size (in global UV space) of the utilSize
tileUvSize: real number representing the size (in global UV space) of one tile
sideShift: real number, equivalent in UV space to the number of pixels to add to the border
innerUvSize: real number, equivalent in UV space to the tile size minus border (in pixels)
vShift: real number, vertical shift in UV space to reach the current line of tiles
destUv: 2D vector of real numbers, destination in UV space of the tile

Variables of the method for generating the UVs are initiatilized as follows:
gridRes=ceil (sqrt (numberOfPatches)), where ceil is a ceiling function that maps a real number x to a least integer greater than or equal to x, sqrt is a square root function, and numberOfPatches is the number of patches obtained after the partitioning of the surface.
tileSize=floor (mapWidth/gridRes), where floor is a floor function that maps a real number x to the greatest integer less than or equal to x.

$$utilSize = gridRes * tileSize$$

$$utilUvSize = utilSize / mapWidth$$

$$tileUvSize = utilUvSize / gridRes$$

$$sideShift = ( dilateSize + paddingSize ) / mapWidth$$

$$innerUvSize = tileUvSize - 2. * sideShift$$

$$vShift = 0.$$

Some steps for the method for generating the UVs are as follows:
For each patch with patch index pIdx do:

$$vShift = \{ \begin{matrix}vShift + tileUvsize & if pIdx \neq 0 AND modulo ( pIdx , gridRes ) = 0 \\ vShift & otherwise\end{matrix}$$

computePatchUVsWithBff (patch, bffFlattenMode)

$$destUV = [ \begin{matrix}tileUvSize * modulo ( pIdx , gridRes ) \\ vShift\end{matrix} ] ,$$

where modulo is an operation that returns the remainder of the Euclidean division of pIdx by gridRes.
For each 2D vector uv coordinate of the patch do:

$$uv = ( uv . innerUvSize ) + destUV + sideShift$$

The BFF [1] UV generator (invoked as computePatchUVsWithBff in the method above) can be executed with different modes; a result of these different modes is illustrated in FIG. 23. The cone mode is the one that generates lowest distortions in the reprojection, but the embodiments provided herein works with all the modes (cone, disk, rectangle, dense matrix).

### Texture Map Reprojection

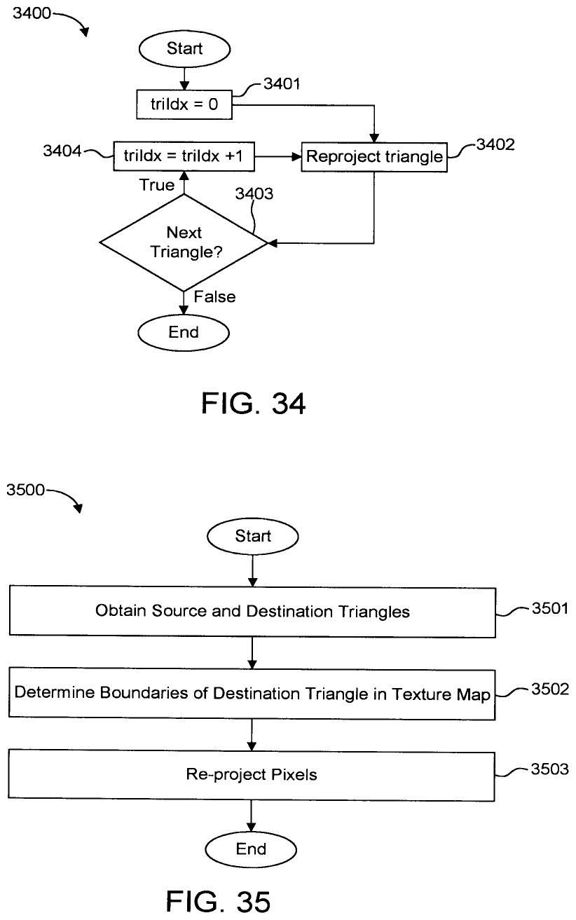

A method for texture map reprojection is described below in relation with FIG. 34-37.

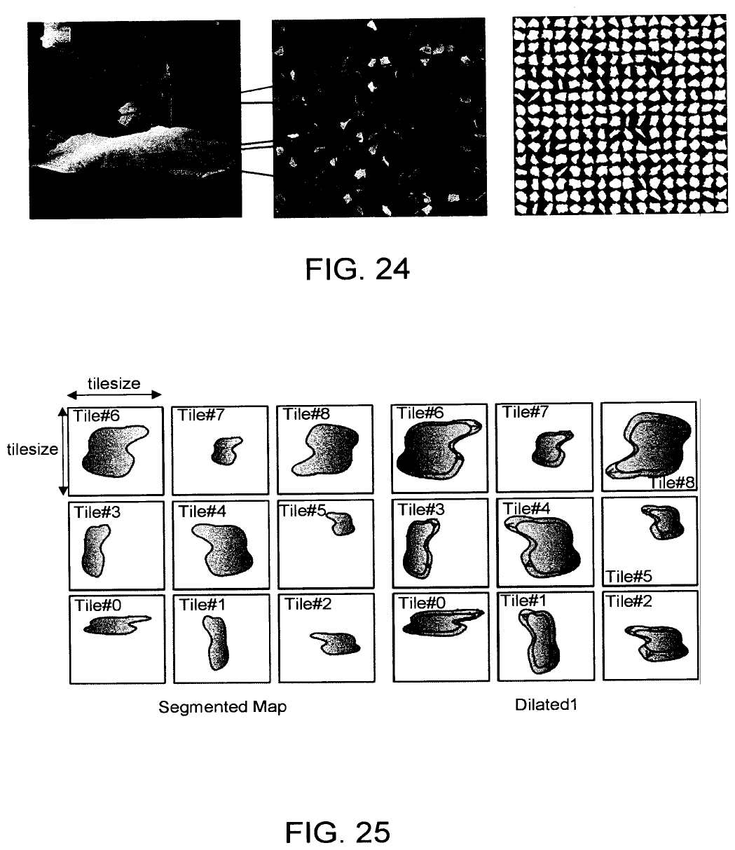

FIG. 24 gives an example of reprojection of the texture map using the UV atlas generation described above. Since the UV coordinates generator allocates patch UVs into a regular grid (see FIG. 21), a set of tiles of regular sizes is obtained, the tiles being spaced with a same number of pixels. Note that although the colored parts of the patches may not be exactly the same shape and size (e.g., as in FIG. 24), they are all found in square tiles of the same size, and some parts of each tile remain black as the colored patches do not necessarily stretch to cover the entire tile. At this step, in some variant, an occupancy map is also generated, which contains for each pixel a 0 if no patch projection exists in the corresponding location in the reprojected texture map and a 1 otherwise.

### Dilation Step

When the end purpose of the volumetric video is rendering, which is the case most of the time, one needs to take care of some renderer specifics. Such a renderer often makes use of texture filtering in image space, such as bi-linear filtering or tri-linear filtering (through Mipmapping). Given a texture UV coordinate, fetching a sample from the texture map for this given UV will look up around the corresponding pixel and blend the values of the sibling pixels. Hence, if such a pixel is on the border of a patch, filtering would lead to improper results by blending some black pixels from the surroundings of the patch, producing dark seams at the patch edges on the rendered surface.

A solution is thus to dilate each patch by a few pixels so that the surroundings of each patch are not made up of black pixels but instead of pixels duplicated from the edge (border) of the patch. FIG. 25 illustrates examples of dilation of patches.

According to an embodiment, patches are dilated by n pixels. The method ingests the re-projected atlas generated with a pre-reserved dilation size of n pixels (see FIG. 22). The method also ingests the occupancy map associated with the patches of the atlas.

The pixels of the texture map are modified as follows, occupancy map is updated accordingly. These steps are successively executed on the entire image n times (each iteration dilates the texture map patches and the occupancy map by one pixel):

A pixel at location i,j in the texture map is modified as follows:

$$\{ \begin{matrix}{pixel}_{i , j} = \{ \begin{matrix}\frac{sum of direct neighbor pixels {pixel}_{k , l} where {OM}_{k , l} \neq 0}{number of direct neighbor pixels {pixel}_{k , l} where {OM}_{k , l} \neq 0} & if {OM}_{i , j} = 0 \\ {pixel}_{i , j} & if {OM}_{i , j} = 1\end{matrix} \\ {OM}_{i , j}^{′} = \{ \begin{matrix}1 & if {OM}_{i , j} = 0 AND ∃ \begin{matrix}at least one \\ direct neighbor {pixel}_{k , l}\end{matrix} where {OM}_{k , l} \neq 0 \\ {OM}_{i , j} & otherwise\end{matrix}\end{matrix}$$

The occupancy map is updated accordingly by: OM_{i,j}=OM′_{i,j}

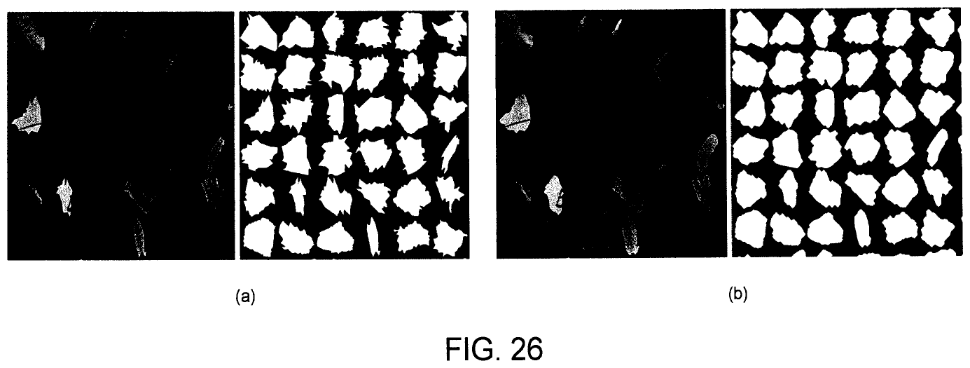

FIG. 26 provides an example of the application of dilation with n=10 to emphasise the results. Usually, n is set to n=2 when using bi-linear filtering, and more when targeting mipmapping (3 to 10 depending on the resolution of the texture map—the larger the map, the higher n must be).

Note that the global approach presented herein can ingest any kind of dilation or even border replication algorithm that would copy data from the inner border of other neighboring patches to the outer border of the treated patch.

### Image Based Tile Tracking

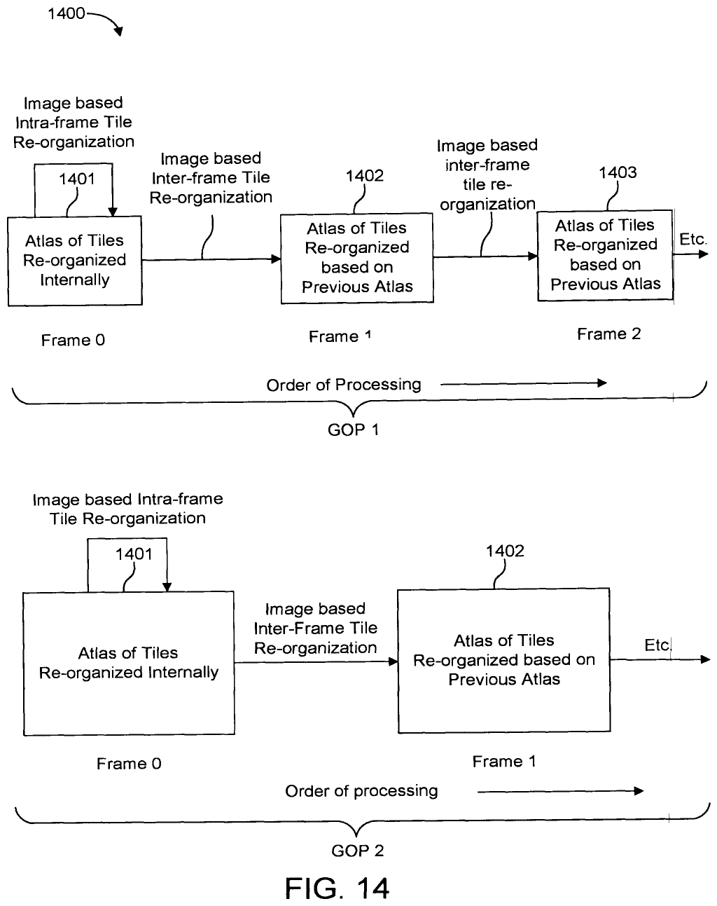

FIG. 14 illustrates an example of a method 1400 for image-based tile tracking according to an embodiment. According to an embodiment, method 1400 works on the generated tiled texture maps using image-based tools to optimize the layout (intra-frame reorganization) and temporal stability (inter-frame tracking) of the tiled texture map to generate a set of “tracked” frames leading to higher compression rates when coded with a video coder. Main steps of this method are depicted in FIG. 14 and detailed further below. Method 1400 works on a group of frames, wherein the atlas of tiles of the first frame 1401 is re-organized internally. In a variant, this image-based intra-frame tile re-organized frame is then used as a reference for image-based inter-frame tile re-organization of subsequent frames of the GOP (1402, 1403). The same is performed for subsequent groups of frames.

### Image Based Intra-Frame Tile Re-Organization

According to an embodiment, this process is applied on the first frame of each GOP. In other variants, it can be applied to each frame of the GOP or sequence.

Looking at FIG. 24, be it on the original atlas or the tiled atlas, one can see that black areas that separate the patches introduce strong signal discontinuities at the boundaries of the patches. Also, even when patches are not separated by empty regions (e.g., black areas between patches in FIG. 24), the transition from one patch to another may present strong color or luminance differences. A solution to reduce this is to introduce some padding to fill the empty areas with data that suits the encoder, especially by smoothing the transitions between patches, using for instance, gradients. The padding process is detailed further below and an example of padded tiled texture can be seen in FIGS. 4, 5 and 32.

Still looking at FIG. 24, one can also see on the tiled version of the texture that tiles, as they are produced according to an embodiment described above, are dispatched in the texture without coherence with their neighbor tiles. An aim of the Image based intra-frame tile re-organization is to reorganize the positions and orientations of the tiles in the texture map to minimize the signal discontinuities between neighboring tiles. Such an operation leads to padding gradients of smaller amplitude, hence improving the compression of the signal by the video coder that relies on inter-block predictions.

According to an embodiment, the image based intra-frame tile re-organization is only performed on the first frame of each GOP. The other frames of the GOP are re-organized using an inter-frame process, hence originally constrained on the re-organized first frame of the GOP. The inter frame re-organization will thus benefit from the intra-frame re-organization of the first frame.

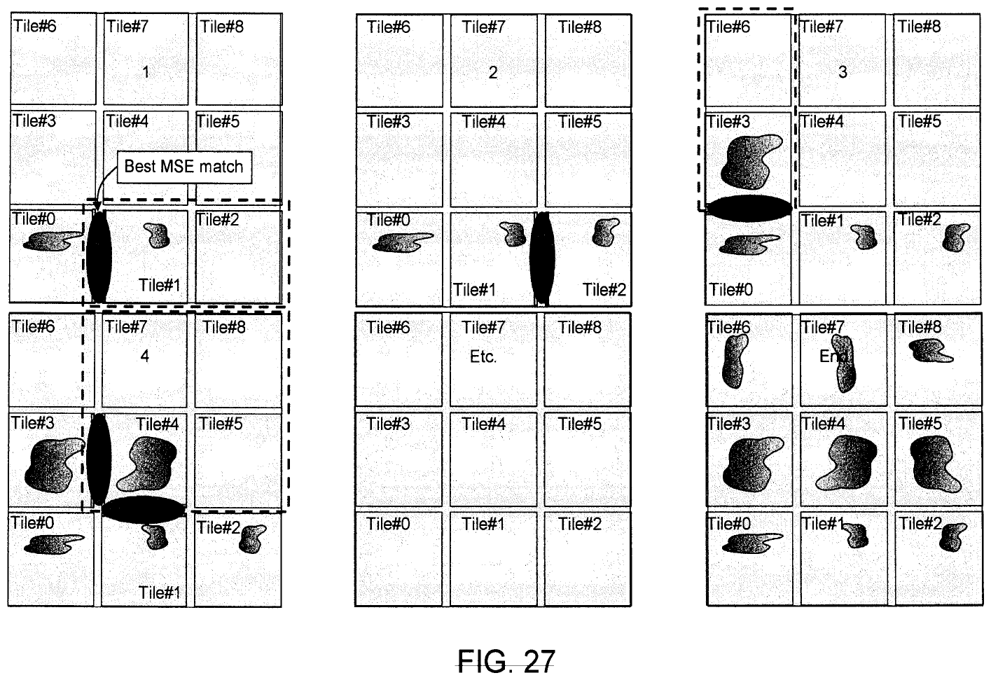

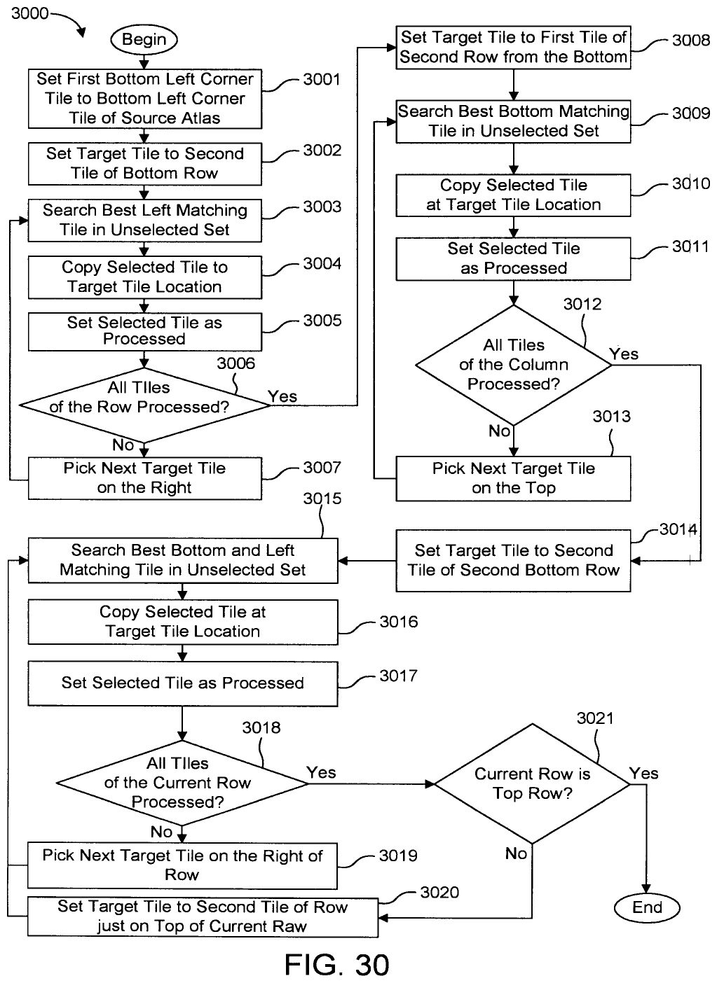

FIG. 27 illustrates the approach to re-organize tiles. Starting from the lower left corner the first tile is kept as it is, then a search is performed amongst all the other tiles that are not already re-organized to find which one would lead to the smoothest inter-tile transition if placed on its right (step 1 on FIG. 27), and the found tile is copied into this place. This process is performed like this until the end of the row (step 2 on FIG. 27). Then for the next row (step 3 on FIG. 27), a search is performed amongst all the other not already re-organized tiles to find which one would lead to the smallest transition if placed on the top of the tile from the previous row. Filling this row is continued (step 4 on FIG. 27) but this time finding the smallest transition between the right of the left tile and the top of the bottom tile. The entire grid is filled by repeating steps 3 and 4 until all the tiles are re-organized. As can be seen, the method can be decomposed into three sub-methods (illustrated on FIG. 30) associated with the re-organization of the following regions:
a. Re-organization of the first row of tiles, except the first corner tile
b. Re-organization of the first column of tiles, except the first corner tile
c. Re-organization of the tiles in all the other rows and columns, except the first corner tile

### Measuring the Cost of Inter-Tile Transitions

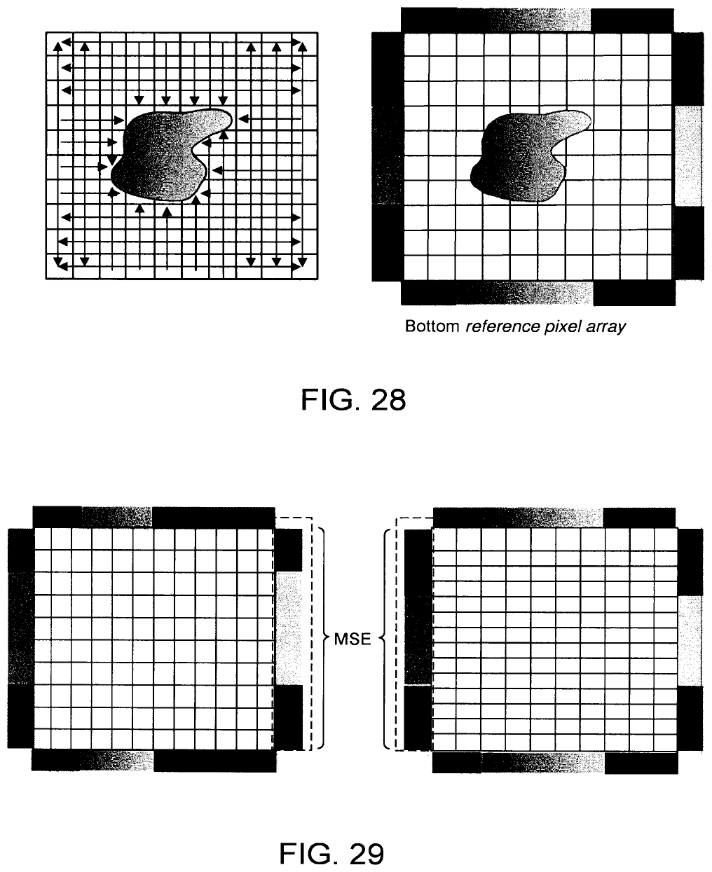

As said before, padding is used at the end of the process. However, padding is computed by interpolating colors between adjacent tiles. Padding is affected by all the surrounding tiles, and the padding cannot be computed for all the possible permutations of tiles in the 2D space due to the complexity cost. Thus, for each tile, some side reference pixel arrays are pre-determined, as illustrated on FIG. 28. These reference pixels (shown in gray on the border of the tile on the right part of FIG. 28, will represent an approximation of the source or destination of the padding (i.e., of the gradient). Determining these pixel arrays is simply performed by running a pixel marching starting from the sides of the tile and collecting for each ray the first encountered pixel that does not have occupancy set in the occupancy map. When no pixel is found on a complete traversal, a black pixel is used in the associated pixel of the reference pixel array that is constructed to indicate an undefined pixel.

In a variant, the line could be stretched toward the corners by duplicating the last non-black pixel (last defined pixel) to avoid undefined pixel in the reference pixel array.

Once the four reference pixel arrays are generated for each tile (one for each side of the tile), two tiles can be compared by any of their sides using an image metric, such as a Mean Squared Error (MSE). FIG. 29 gives an example for comparison with the vertical columns of two tiles.

When comparing one tile to two other tiles at the same time, as in FIG. 27.c, the sum of the two MSEs is used to compare with other possible tiles.

An optional variant of the method to get even better inter-tile transitions is to “transform” the not already re-organized tiles by 90/180/240 degrees rotations and/or mirroring when comparing tiles. In fact, since the pixel reference array is available, the tiles do not need to be really transformed; rather the proper pixel reference array is selected and scanned in a mirrored fashion if needed to reflect the expected tile transformation. This option of transforming the patches is a parameter of the encoder, which when activated produces better intra-reorganization at a cost of additional combinatorial computations.

Once the best tile is selected according to these criteria, the pixels of the tile are transformed in the image to place the tile in its new location by performing a translation of the tile's original position and optionally a rotation or mirroring prior to the translation. This is performed by simply controlling the scan order during sub-image copy.

If it is intended to visualize the mesh before encoding, the associated UV coordinates of the associated sub-mesh are also transformed, so they reflect this transformation:

### Rotating UV Coordinates of a Patch:

translate by (−0.5, −0.5),
multiply by 2D matrix of rotation
translate back by (0.5, 0.5).

### Mirroring UV Coordinates of a Patch:

translate by (−0.5, −0.5),
scale by −1 on mirroring direction,
translate back by (0.5, 0.5).

In an embodiment according to which, the UV coordinates are not coded in a bitstream but generated in a similar manner at the decoder side, a tile transform table is generated for the encoding/decoding process. According to this embodiment, information relating to reorganization and transformation of the tiles is stored in a “table”. This information (the “table”) is then coded as meta-data in the bitstreams. In this way, at decoding, after the re-generation of UV coordinates is performed on the decoded mesh, transformations of the UV coordinates of the tiles are applied using the “table” to find the proper UV atlas that corresponds to the re-organized decoded texture map. Details description of the encoding of this table is given further below.

FIG. 30 illustrates a method 3000 for image-based intra-frame tile re-organization according to an embodiment. At 3001, the first bottom left corner tile of the texture map is set to the bottom left corner tile of the source atlas. At 3002, the target tile that is search is set to the second tile of the bottom row (on the right of the first bottom left corner tile). At 3003, a best left matching tile is searched in a set of tiles that comprises all the unselected tiles. The best left matching tile is searched by comparing the right side of the tile located on the left of the target tile location and the left side of the current unselected tile (steps, 1, 2 of FIG. 27). At 3004, the best left matching tile is copied to the target tile location. At 3005, the tile that is selected as the best left matching tile is set to processed and removed from the unselected tiles set. At 3006, it is checked whether all tiles of the row have been processed. If not, then at 3007, the next target tile on the right in the texture map is selected as the target location and process iterates at 3003 for this location. This part of the process fills the last row of the texture map. If at 3006, all the tiles of the row have been processed, then at 3008, the target tile is set to the first tile of the second row from the bottom. At 3009, a best bottom matching tile is searched in a set of tiles that comprises all the unselected tiles. The best bottom matching tile is searched by comparing the upper side of the tile located below the target tile location and the bottom side of the current unselected tile (step 3 of FIG. 27). At 3010, the best bottom matching tile is copied to the target tile location. At 3011, the tile that is selected as the best bottom matching tile is set to processed and removed from the unselected tiles set. At 3012, it is checked whether all tiles of the column have been processed. If not, then at 3013, the next target tile on top of the current target location in the texture map is selected as the new current target location and process iterates at 3009 for this location. This part of the process then filled the first column of the texture map. If at 3012, all the tiles of the column have been processed, then at 3014, the target tile is set to the second tile of the second row from the bottom.

At 3015, a best bottom and left matching tile is searched in a set of tiles that comprises all the unselected tiles. The best bottom and left matching tile is searched by comparing the upper side of the tile located below the target tile location with the bottom side of the current unselected tile and the right side of the tile located on the left of the target tile location with the left side of the current unselected tile (step 4 of FIG. 27). At 3016, the best bottom and left matching tile is copied to the target tile location. At 3017, the tile that is selected as the best bottom and left matching tile is set to processed and removed from the unselected tiles set. At 3018, it is checked whether all tiles of the row have been processed. If not, then at 3019, the next target tile on the right of the current target location in the texture map is selected as the new current target location and process iterates at 3015 for this location. This part of the process then filled a row of the texture map. If at 3018, all the tiles of the row have been processed, then at 3021, it is checked whether the current row is the top row of the texture map. If not, then at 3020, the target tile is set to the second tile of the row that is above the current row and the process iterates at 3015. If at 3021, the current row is the top row of the texture map, then all tiles of the texture map have been reorganized and the process ends.

### Image Based Inter-Frame Tile Re-Organization

The inter-frame re-organization is simpler than intra-frame re-organization. It relies on full tile MSE comparisons with full tiles of the previous frame. At this stage, optionally the tiles can also be rotated and mirrored, but this is also performed on full tiles instead of on pixel reference arrays. As depicted in FIG. 14, for each GOP, the tiles of frame 1 are re-organized with reference to frame 0, the tiles of frame 2 are re-organized with reference to frame 1, and so on until the end of the GOP. Frame 0 of each GOP is not concerned by inter-frame re-organization.

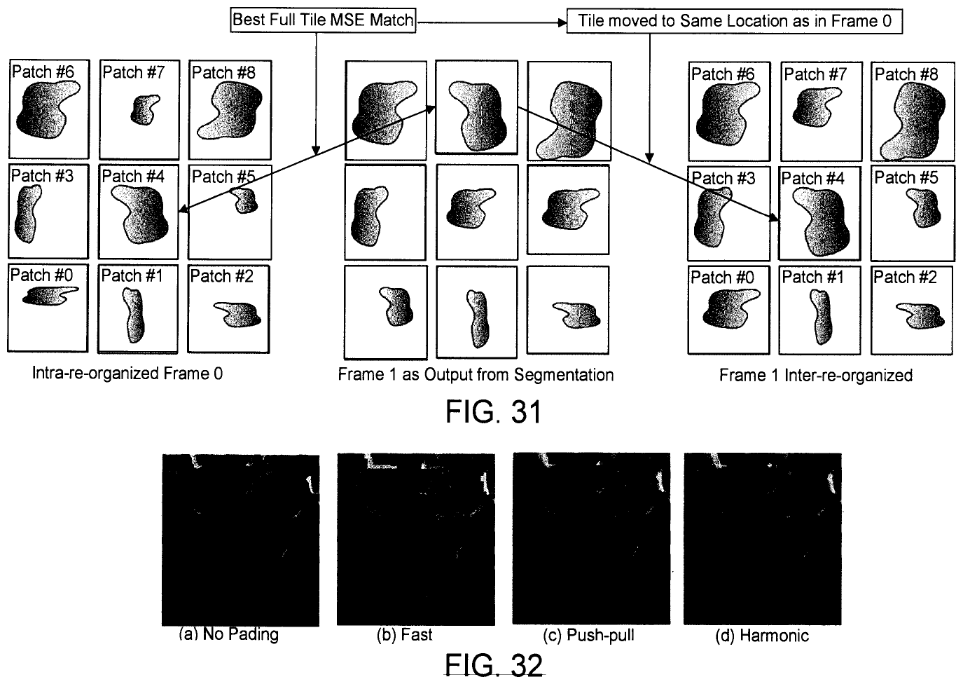

FIG. 31 gives an example of the process of inter-frame re-organization for one frame. As for the intra-frame re-organization, according to an embodiment, in addition to an updated image texture, a tile transform table is generated for the frame. The steps to treat a frame n constrained by a frame n−1 are the following:
Let Fn be the frame n with non-re-organized tiles.
   Let RFn be the frame n with re-organized tiles (algorithm output).
      The tiles that have been already re-organized in a frame are kept tracked.
   For each tile, noted Tₙ₋₁, of frame n−1 do:
   Search for a tile, noted Tₙ, in all the non-re-organized tiles from Fn that minimizes an image metric, for instance the MSE (Tₙ₋₁, Tₙ)
   Additionally, the rotated and mirrored version of Tₙ can be included in the minimization.
   Once found, the tile Tₙ that minimized the metric is copied into RFn and mark Tₙ as re-organized,
   The tile transformation table is updated for the frame with related information.

Another variant for selecting transforms having complexity of (O(N×N)) but more efficient in term of resulting selection of transforms can also be implemented. Since the solution generally uses no more than 1024 tiles this complexity is still practicable. In this variant all the tiles of previous frame are tested against all the tiles of current frames using the image metric (for instance the block MSE with optional mirroring and rotations). The obtained pairs of tiles are then sorted according to their metric result and the subset of unique pairs (which size is the number of tiles) minimizing the sum of their metric results is the set retained for the transformation.

### Tile Transformation Table

Table 1 below represents an example for encoding the tile transformation table. This table is used to re-organize the tiles after decoding once the UV atlas re-generation has been performed. In this embodiment, each integer is encoded in the dynamic range necessary to encode Nₜ values (where Nₜ is the number of tiles).

The first column indicates a table entry index n with n corresponding to the index of the tile to be transformed (this column is implicit is not coded in the bitstream).

The second column indicates the destination index, it is an integer coded in dynamic range for Nₜ tiles. The third column indicates whether rotation occurs and which angle 0, 90, 180, 240, 2 bits are used to encode the 4 possibilities. The fourth column indicates whether mirroring and which direction is used among vertical (V), and horizontal (H) and combinations of vertical and horizontal. One bit per transformation is used.

TABLE 1
example of coding of tile transformations. Nₜ is the number of tiles.

| | Destination | | |
|---|---|---|---|
| n | index | Rotation | Mirroring |
| 0 | d0 | 00 (0 degrees) | 00 (none) |
| 1 | d1 | 10 (90) | 01 (V only) |
| 2 | d2 | 11 (240) | 11 (H + V) |
| 3 | d3 | 01 (180) | 10 (H only) |
| Etc. | | | |

Table 1 is only one example, other signaling of the information for updating the UV coordinates can be used for more or less data than in table 1.

In a table of Nₜ entries, each entry corresponding to the transformation to apply to tile n is stored. The ordering of the tiles that is considered in the 2D array is from bottom to top and left to right to prevent the need to encode separately the row and columns indices for each tile (any other implicit ordering could be used as an alternative). In this way the destination of a tile is coded using only one integer (its origin is implicit from its index in the transformation table).

### Inter-Tile Padding

In an embodiment, the padding process is individually performed on all frames.

Several solutions can be used to compute the padding. For example, three modes (fast, push-pull and harmonic) are implemented in the MPEG V-PCC standard (2020—ISO/IEC FDIS 23090-5:2020, Information technology—Coded representation of immersive media—Part 5: Visual Volumetric Video-based Coding (V3C) and Video-based Point Cloud Compression (V-PCC)). These methods ingest the original non-padded texture atlas plus an occupancy map that indicates for each pixel whether it belongs to a patch or if it is an empty space to be filled by the padding. FIG. 32 gives some examples of these three different padding methods applied to the tiled texture maps obtained according to the embodiments described above. Applying a padding leads to better compression ratios by removing strong signal transitions in the images. Thanks to the intra and inter re-organization described above, the size of the signal steps is further reduced, hence leading to a very efficient padding effect, especially when using push-pull and harmonic modes that generate soft gradients between tiles.

As described above, the possibility of adding a space between the tiles is discussed for the dilate step but also to get better padding. Indeed, if the non-empty parts of two neighbor tiles are touching each other and if these two patches have different signal values on the border, there is no room to introduce a gradient in between (since they are touching each other). Therefore, a pixel border of optional size (0 to n pixels) is introduced around each tile to ensure that there will always be room to generate a minimal gradient (a pixel border of 0 deactivates this feature).

### Extension to Handle Non-Manifold Meshes

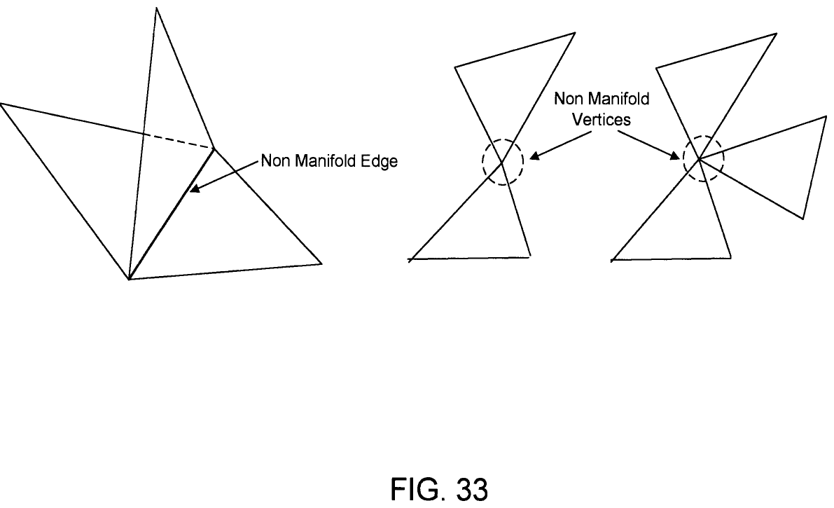

In some cases, the input mesh might not present clean topology, or the mesh subdivision might generate some patches with topology issues (e.g. illustrated in FIG. 33). This is not an issue for most parts of the algorithm; however, BFF requires manifold meshes in order to work properly. It is thus needed to clean up the mesh prior to applying the algorithm or clean up each patch prior to processing it with BFF. For more robustness it is decided, in an embodiment, to pre-process each patch individually.

According to this embodiment, all the triangles that share a non-manifold edge or a non-manifold vertex from the patch are removed and placed in a separate triangle set where triangles have unique vertex indices (i.e. vertices are not shared amongst faces but rather duplicated). UVs are then determined for the “clean” patch with BFF and the patch is encoded without the faces that were removed. The separate triangle set is then unwrapped independently with all the faces considered as individual, which BFF knows how to handle.

The part relative to the triangles of the separate triangle set is reprojected to a reserved tile of the texture atlas (e.g. the top right one), and this tile is excluded from the tile tracking (intra and inter reorganizations). The same filtering of non-manifold faces is performed at decoding and produces a complete mesh. Note that this solution, even if efficient, may lead, in the case of many non-manifold elements, to higher texture distortions on the concerned triangles since all the triangles of the separate triangle set are re-projected into a single tile.

An example of an embodiment for reprojecting an input texture map to a destination texture map is described below. This method can be used for instance in step 1313 of FIG. 13 for obtaining the texture map having regular grid tiles using the UV coordinates obtained at 1311. FIG. 34 illustrates an example of a method 3400 for reprojecting the texture map, according to an embodiment. Some variables are described below for easier understanding.

### Notations:

In the following the ‘*’ character denotes the standard multiplication.

In the following the ‘⋅’ character denotes the dereference of a value of a field of values (e.g. vec.x accesses the x field of the vector vec).

### Input Parameters:

srcModel: the source mesh with original UVs
dstModel: the destination mesh with its new UVs (UV obtained on the regular grid of tiles)
inputMap: a two-dimensional array of colors, the input texture map
outputMap: a two-dimensional array of colors, the reprojected texture map
useFaceMapping: a Boolean set to true if source and destination meshes are not identically indexed
modelFaceMapping: table that associates destination triangle index with source triangle index

### Variables:

srcV1, srcV2, srcV3: source triangle vertices; each vertex contains a UV 2D vector and a position 3D vector of real values,
dstV1, dstV2, dstV3: source triangle vertices; each vertex contains a UV 2D vector and a position 3D vector of real values,
scrTriIdx: source triangle index: an integer
uvMin: a vector of two components, each component is a real value
uvMax: a vector of two components, each component is a real value
intUvMin: a vector of two components, each component is an integer value
intUvMax: a vector of two components, each component is an integer value
dstUV: a vector of two components, each component is a real value
srcUV: a vector of two components, each component is a real value
bary: a vector of three components, each component is a real value
srcCol: a color (any representation is possible but must fit the one of the colors stored in inputMap and outputMap).

The method 3400 loops over all the triangles of the new mesh with the new UV atlas and reproject (3402) each triangle from the original texture map to the new texture map. For that, at 3401, a variable triIdx indicating the index of a current triangle of the new mesh is initialized to 0. At 3402, the current triangle is re-projected. A method for reprojecting the triangle is described below. At 3403, it is checked whether all the triangles of the new mesh have been reprojected. If not, then the process passes to the next triangle at 3404. Otherwise, the process ends.

FIG. 35 illustrates an example of a method 3500 for reprojecting a triangle, according to an embodiment. At 3501, the source (i.e. original) and destination (i.e. new) triangles are fetched, i.e. their vertices are retrieved from memory. At 3502, the bounding box of the new triangle in the new texture map is determined.

An example of source code for determining the bounding box of the new triangle is provided below:

| // compute the UVs bounding box for the destination triangle
| uvMin = { MAX_REAL , MAX_REAL }
| uvMax = { − MAX_REAL, − MAX_REAL }
| // with min and max functions working per component
| uvMin = min(dstV3.uv, min(dstV2.uv, min(dstV1.uv, uvMin)))
| uvMax = max(dstV3.uv, max(dstV2.uv, max(dstV1.uv, uvMax)))
|
| // find the integer coordinates covered in the map
| intUvMin = { inputMap.width * uvMin.x, inputMap.width * uvMin.y }
| intUvMax = { inputMap.width * uvMax.x, inputMap.width * uvMax.y }
| // with min and max functions working per component
| intUvMin = max(intUvMin, {0, 0})
| intUvMax = min(intUvMax, {inputMap.width − 1, inputMap.width − 1} )

At 3503, pixels of the new triangle are projected. That is, the pixels inside of the bounding box of the new triangle are parsed and each pixel belonging to the new triangle is assigned a color value obtained based on the source texture map.

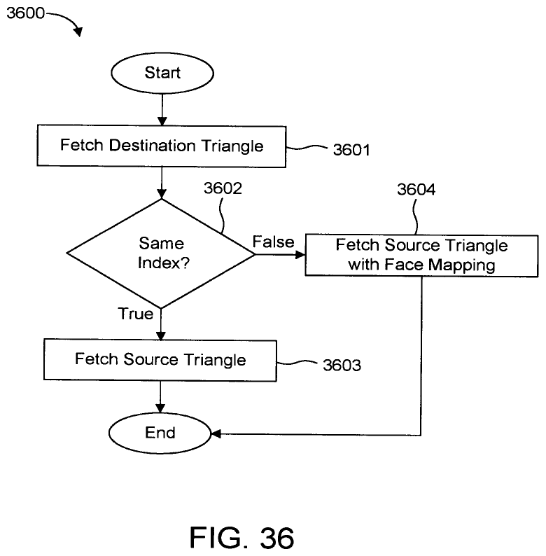

FIG. 36 illustrates an example of a method 3600 for fetching a triangle from the new mesh (new triangle) and a corresponding source triangle, according to an embodiment. At 3601, vertices of the new triangle are obtained. At 3602, it is checked whether the source and new meshes are identically indexed. If this is the case, then the index of the current triangle of the new mesh is the same as the corresponding triangle in the source mesh. So, at 3603, the vertices of the source triangle are retrieved. Otherwise, at 3604, an index for the source triangle is obtained from the modelFaceMapping table using the index of the current triangle.

The table modelFaceMapping associates the new triangle index with index of triangles in the source mesh. The table can be determined for instance when encoding the topology of the source mesh.

Since the modelFaceMapping table is only needed when obtaining the new texture map, and the new texture map is then encoded in the bitstream, there is no need to encode the modelFaceMapping table. Then at 3604, vertices of the source triangle indexed by the obtained index are retrieved.

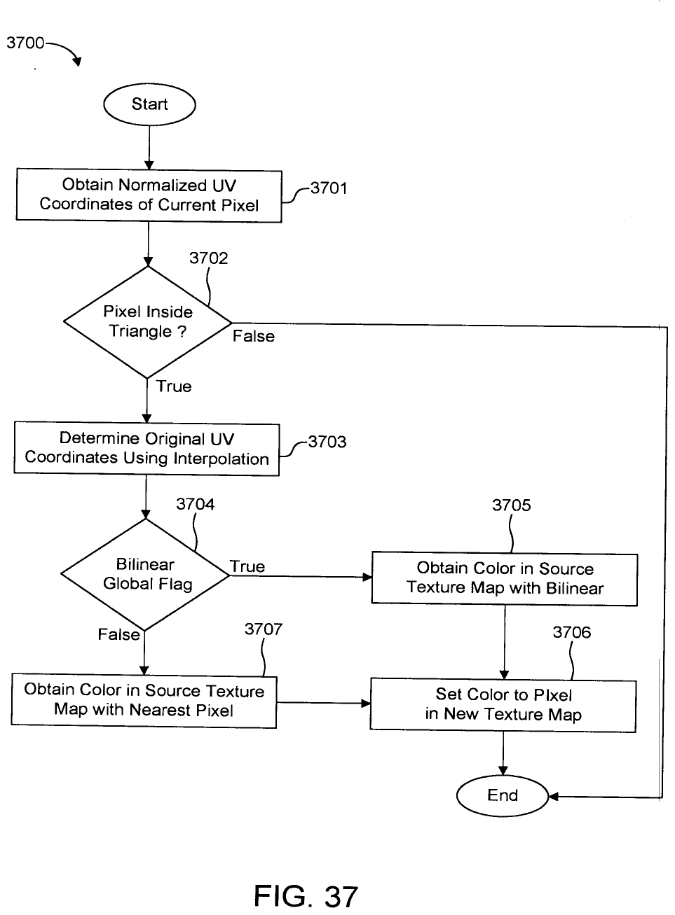

FIG. 37 illustrates an example of a method 3700 for reprojecting a pixel, according to an embodiment. Method 3700 can be used for instance at 3503 of method 3500. At 3701, normalized UV coordinates of a current parsed pixel of the new triangle bounding box determined at 3502 are obtained. For that, dstUV is initialized with the uv coordinate corresponding to the center of the pixel with coordinate (i,j) as dstUV={(0.5+i)/inputMap.width, (0.5+j)/inputMap.height};

At 3702, it is checked whether the current pixel is inside the new triangle. A function getBarycentric is used where it returns true if dstUV is inside the triangle made of (dstV1.uv, dstV2.uv, dstV3.uv), and false otherwise. The Boolean output is set to the variable inside=getBarycentric (dstUV, dstV1.uv, dstV2.uv, dstV3.uv, bary). The function computes the barycentric coordinates (u, v, w)˜res (x,y,z) for a point p with respect to a triangle (a, b, c). Example of source code for the function is given below:

```
bool getBarycentric(glm::vec2 p, glm::vec2 a, glm::vec2 b, glm::vec2 c, glm::vec3& res)
{
  glm::vec2 v0 = b − a, v1 = c − a, v2 = p − a;
  float den = v0.x * v1.y − v1.x * v0.y;
  float u = (v2.x * v1.y − v1.x * v2.y) / den;
  float v = (v0.x * v2.y − v2.x * v0.y) / den;
  float w = 1.0f − u − v;
  res.x = u; res.y = v; res.z = w;
  if (0 <= u && u <= 1 && 0 <= v && v <= 1 && u + V <= 1)
    return true;
  else
    return false;
}
```

If the current pixel is inside the new triangle, at 3703 original UV texture coordinates are determined for the current pixel. For instance, interpolation is used using the original UV texture coordinates associated to the source triangle that corresponds to the new triangle.

Example of source code for the function that computes the position of a point from triangle (v0, v1, v2) and barycentric coordinates (u, v) is given below:
inline void triangleInterpolation (const glm::vec3& v0, const glm::vec3& v1, const glm::vec3& v2, float u, float v, glm::vec3& p)

$$\{ p = v 0 * ( 1. f - u - v ) + v 1 * u + v 2 * v ; \}$$

At 3704, it is checked which method to use for determining the color for the current pixel. If bilinear interpolation is used, then at 3705, the color is obtained from the source texture map using bilinear interpolation and the UV texture coordinates determined at 3703.

Otherwise, at 3707, the color is obtained from the source texture map using nearest pixel and the UV texture coordinates determined at 3703. At 3706, the determined color is assigned to the current pixel of the new texture map.

In the above method, several methods have been used for determining the color for a pixel in the source texture map. In some embodiments, only one method could be available so that no selection of a method is needed. In other embodiments, other methods are possible, a selection among the possible methods could be signaled, or a default method among the possible methods could be used by default.

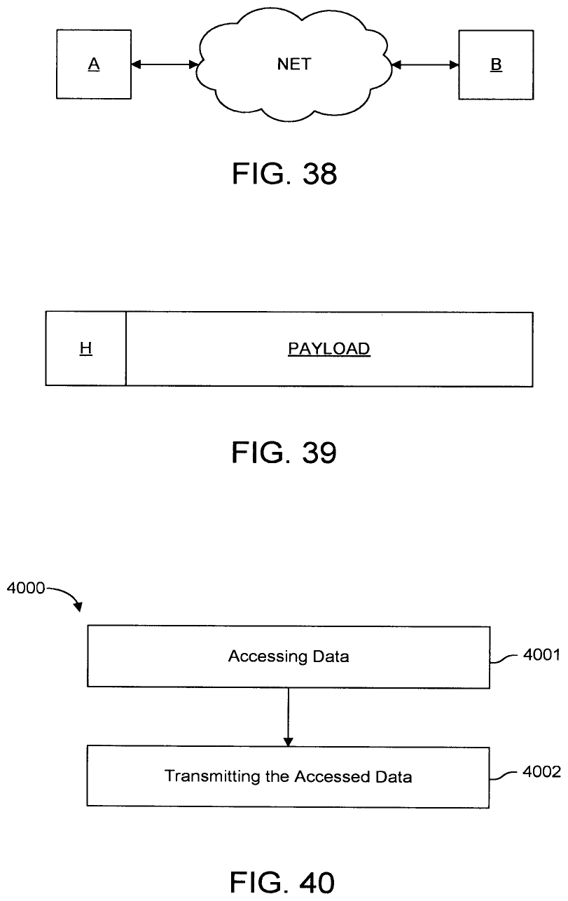

According to an example of the present principles, illustrated in FIG. 38, in a transmission context between two remote devices A and B over a communication network NET, the device A comprises a processor in relation with memory RAM and ROM which are configured to implement a method for encoding a textured mesh according to an embodiment as described in relation with the FIGS. 1-37 and the device B comprises a processor in relation with memory RAM and ROM which are configured to implement a method for decoding a textured mesh according to an embodiment as described in relation with FIGS. 1-37.

In accordance with an example, the network is a broadcast network, adapted to broadcast/transmit a signal from device A to decoding devices including the device B.

A signal, intended to be transmitted by the device A, carries at least one bitstream generated by the method for encoding a textured mesh according to any one of the embodiments described above. According to an embodiment, the bitstream comprises coded video data representative of a texture map comprising a regular grid of tiles, wherein each tile comprises texture data associated to a patch projected onto said tile, said patch belonging to a partitioning of a surface of a textured mesh. In some embodiments, the bitstream also comprises at least one of the following data:
coded data representative of UV coordinates on the regular grid of tiles for at least one patch of the textured mesh,
an information for updating UV coordinates on the regular grid of tiles obtained for at least one patch of the textured mesh
when the texture map corresponds to texture data of a first frame of the textured mesh and the textured mesh comprising at least one other frame, a subsequent texture map and an information for updating UV coordinates in the subsequent texture map and obtained for patches of the at least one other frame,
data representative of a topology or connectivity of the textured mesh,
data representative of vertices positions of the textured mesh.

FIG. 39 shows an example of the syntax of such a signal transmitted over a packet-based transmission protocol. Each transmitted packet P comprises a header H and a payload PAYLOAD.

FIG. 40 illustrates an embodiment of a method 40500) for transmitting a signal according to any one of the embodiments described above. Such a method comprises accessing data (4001) comprising such a signal and transmitting the accessed data (4002) via a communication channel that may be implemented, for example, within a wired and/or a wireless medium. According to an embodiment, the method can be performed by the device 100 illustrated on FIG. 1 or device A from FIG. 37.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method comprising:
obtaining a partitioning of a surface of a textured mesh by subdividing the surface of the mesh into a set of patches, the patches having approximately equal area and size, and
encoding a texture map comprising a regular grid of tiles, wherein each tile comprises texture data associated to a patch of the set projected onto the tile.

2. An apparatus comprising one or more processors configured to:
obtain a partitioning of a surface of a textured mesh by subdividing the surface of the mesh into a set of patches, the patches having approximately equal area and size, and
encode a texture map comprising a regular grid of tiles, wherein each tile comprises texture data associated to a patch of the set projected onto the tile.

3. The method of claim 1 further comprising obtaining UV coordinates on the regular grid of tiles for at least one patch of the textured mesh.

4. The method of claim 3, wherein the texture map is obtained by projecting an input texture map on the regular grid of tiles using input UV coordinates of vertices of the textured mesh and the obtained UV coordinates.

5. The method of claim 1, wherein a patch is a sub-mesh of the mesh.

6. The method of claim 1, wherein the patches have a same shape and/or size.

7-8. (canceled)

9. The method of claim 1, wherein obtaining the partitioning includes:
selecting a set of faces on the surface that maximizes an inter-face distance between faces of the set, and
allocating, each other face of the mesh, to a face of the set that is nearest from the other face.

10. The method of claim 3, wherein obtaining UV coordinates comprises obtaining UV coordinates for each vertex of the mesh that belongs to the at least one patch.

11. The method claim 3, wherein obtaining UV coordinates comprises arranging the at least one patch in a coordinate system that comprises all the patches of the partitioning.

12. (canceled)

13. The method claim 3, wherein tiles are spaced by a given number of pixels on the grid.

14. The method claim 4, further comprises, for at least one patch, dilating texture data associated to the at least one patch, in the texture map by a given number of pixels.

15. (canceled)

16. The method of claim 3, further comprising arranging the tiles of the texture map based on an inter-tile transitions cost.

17. The method of claim 16 further comprising updating the obtained UV coordinates based on the arrangement of the tiles.

18. (canceled)

19. The method of claim 1, wherein the method further comprises arranging tiles of the texture map based on a distortion cost between at least one tile of the texture map and at least one tile of a reference texture map.

20. The method of claim 19 further comprising updating UV coordinates based on the arrangement of the tiles of the texture map.

21. The method of claim 19 further comprising storing an information for updating UV coordinates based on the arrangement of the tiles of the texture map.

22-23. (canceled)

24. A method comprising decoding a texture map comprising a regular grid of tiles, wherein each tile comprises texture data associated to a patch projected onto the tile, wherein the patch belongs to a set of patches from a partitioning of a surface of a textured mesh, and wherein the patches have approximately equal area and size.

25. An apparatus comprising one or more processors configured to decode a texture map comprising a regular grid of tiles, wherein each tile comprises texture data associated to a patch projected onto the tile, wherein the patch belongs to a set of patches from a partitioning of a surface of a textured mesh, and wherein the patches have approximately equal area and size.

26-33. (canceled)

34. A computer readable storage medium having stored thereon instructions for causing one or more processors to perform the method of claim 1.

35. The apparatus according to claim 25, and at least one of (i) an antenna configured to receive a signal, the signal including data representative of at least one part of a textured mesh, (ii) a band limiter configured to limit the received signal to a band of frequencies that includes the data representative of the at least one part of the textured mesh, or (iii) a display configured to display at least one part of a three dimensional (3D) object reconstructed from signal.

36. The apparatus according to claim 35, comprising a television (TV), a cell phone, a tablet or a set top box.

37. A computer readable storage medium having stored thereon a bitstream comprising coded video data representative of a texture map comprising a regular grid of tiles, wherein each tile comprises texture data associated to a patch projected onto the tile, wherein the patch belongs to a set patches from a partitioning of a surface of a textured mesh, and wherein the patches have approximately equal area and size.

38. (canceled)

39. The computer readable storage medium of claim 37, further comprising at least one of:
coded data representative of UV coordinates on the regular grid of tiles for at least one patch an information for updating UV coordinates on the regular grid of tiles obtained for at least one patch of the textured mesh,
data representative of a topology of the textured mesh, and
data representative of vertices positions of the textured mesh.

40-41. (canceled)

42. The apparatus of claim 2, wherein the one or more processors being configured to obtain the partitioning comprises the one or more processors being configured to:
select a set of faces on the surface that maximizes an inter-face distance between faces of the set, and
allocate, each other face of the mesh, to a face of the set that is nearest from the other face.

43. The apparatus of claim 2, wherein the one or more processors are further configured for arranging the tiles of the texture map based on an inter-tile transitions cost.

44. The apparatus of claim 2, wherein the one or more processors are further configured for arranging tiles of the texture map based on a distortion cost between at least one tile of the texture map and at least one tile of a reference texture map.
